(19) United States
(12) Patent Application Publication
(10) Pub. No.: US 2016/0008812 A1
(43) Pub. Date: Jan. 14, 2016

(54) FLUIDIC DEVICE AND FABRICATION METHOD THEREOF, AND THERMAL TRANSFER MEDIUM FOR FLUIDIC DEVICE FABRICATION

(71) Applicant: Rie KOBAYASHI, (US)

(72) Inventor: Rie KOBAYASHI, Shizuoka (JP)

(21) Appl. No.: 14/771,377

(22) PCT Filed: Feb. 28, 2014
(86) PCT No.: PCT/JP2014/055884

§ 371 Date: Aug. 28, 2015

(30) Foreign Application Priority Data
Feb. 28, 2013 (JP) 2013-038834
May 30, 2013 (JP) 2013-114411
Sep. 19, 2013 (JP) 2013-194560
Jan. 10, 2014 (JP) 2014-002861

(51) Int. Cl. B01L 3/00

(52) U.S. Cl. CPC B01L 3/502746; B01L 3/502707; B01L 2300/0851; B01L 2400/08; B01L 2300/12; B01L 2300/0636; B01L 2300/089

(57) ABSTRACT

Provided is a fluidic device including: a base member; a porous layer provided over the base member; a flow path wall provided in the porous layer; and a flow path defined by an inner surface of the flow path wall and the base member. Linearity of the fluidic device is 30% or less, where the linearity is obtained by the following formula: Linearity (%)={[A (mm)−B (mm)]/B (mm)}×100, where a length B is a length of a straight line between arbitrary two points on a contour of the inner surface of the flow path wall, and a length A is a length of a continuous line between the two points.

### TECHNICAL FIELD

The present invention relates to a fluidic device and a fabrication method thereof, and a thermal transfer medium for fluidic device fabrication.

### BACKGROUND ART

Along with the recent development of nanotechnologies, device miniaturization has advanced in various fields. Examples include miniaturization of reaction devices with a view to minimizing the amount of use of organic solvents that have great environmental impacts, and miniaturization of simple analytical devices for fieldwork that are required to be portable. Small-size analytical devices are also demanded in the field of biosensors for blood testing and DNA testing, in the field of quality control for foods and beverages, etc. Microfluidic devices have been paid attention as a technology that can cater to these applications. A microfluidic device is a palm-size substrate (or a cube) that includes a plurality of minute flow paths through which a sample liquid containing an analyte, a reaction reagent, etc. are conveyed, and a reaction region in which reactions of the reagent or the like take place. The microfluidic device allows various types of operations with the minute flow paths and the reaction region, such as chemical reactions, genic reactions, separation, mixing, assays, etc.

Microfabrication techniques developed in the semiconductor technology are applied to the conventional microfluidic devices; silicon, plastic, glass, etc. are used as a substrate. However, photolithography, which is an example technique for fabricating microfluidic devices by using a substrate, involves many steps such as immersion of a photoresist, thermal treatment, ultraviolet (UV) irradiation, removable of the photoresist, etc. Many solvents and reagents are required for the photoresist, a washing liquid for removing the photoresist, a cleaning room, a mask, a UV light source, etc., large-scale equipment is required, and high-level expertise is required. Labor costs, material costs, etc. required for fabricating the microfluidic devices have raised the prices of the microfluidic devices, which thus have failed to be practically usable in the business.

For the miniaturization of the devices, it is advantageous if the structure and mechanism of the devices are simple. In applications for chemical analyses or biochemical analyses, the devices are required to be inexpensive as well as small, because they must be disposable. Hence, for example, there is proposed a chemical analytical film that can eliminate wasting of expensive samples or reagents for chemical analysis (see PTL 1).

This chemical analytical film is a chemical analytical film made of, for example, a nitrocellulose film, and a region to be used and a region not to be used are defined in the film by wax impregnation. However, in this chemical analytical film, a flow path is formed in the direction perpendicular to the film surface. Therefore, the problem of this film is that a flow path can be formed only to a length corresponding to the thickness of the film.

Further, as relatively inexpensive and simple microfluidic devices, there are proposed “μPADs” (microfluidic paper-based analytical devices), which are microfluidic device, of which base member is paper (see PTL 2).

The “μPADs” are fluidic devices, of which base member is paper, and that include a flow path formed by a hydrophobic resin. In the paper material, a hydrophilic region and a hydrophobic region are defined by the hydrophobic resin. In early models of “μPADs”, a flow path is formed so as to let a fluid flow in the direction of the thickness of the paper, with a photolithography technique that uses a polymerized photoresist.

Recently, there has been a report on a flow path forming method that uses a printing technique such as inkjetting, as an inexpensive and easily available method.

However, it is difficult to form a minute flow path that would realize a stable flow velocity with the inkjetting technique, because inks tend to bleed. Furthermore, questions have been raised against the sensitizing property of VOCs (volatile organic compounds) and ultraviolet (UV) curable resins included in the inks, which are not suitable materials for biochemical fields.

There has also been a report on a flow path forming method with a wax printer using phase change inks (see NPL 1 and PTL 3). However, conventional inks are designed to have the resin component thereof stopped at the surface of the paper. Therefore, simply printing the inks does not let the resin component penetrate into the paper, and it has been difficult to define a hydrophilic region and a hydrophobic region in the paper.

PTL 4 proposes a paper-based reaction chip, in which a fluid flows in the planar direction of the paper, unlike PTLs 1 to 3. When a fluid flows in the planer direction of the paper as in this proposal, the sample liquid may evaporate to change the flow rate and flow velocity, which would influence the analytical result. Therefore, PTL 4 forms a cover, with an inkjet printer and an ultraviolet curable ink. However, as described in PTL 4, inks have a property to penetrate into the paper to a certain depth from the surface. It is difficult to control the penetration depth. Particularly, when printing the ink on a thin sheet with a thickness of about 100 μm, it is considered difficult to manufacture a cover.

### CITATION LIST

### Patent Literature

PTL 1 Japanese Patent Application Laid-Open (JP-A) No. 08-233799

PTL 2 Japanese Patent Application Publication (JP-B) No. 2010-515877

PTL 3 JP-A No. 2012-37511

PTL 4 International Publication No. 2012/160857

### Non-Patent Literature

NPL 1 E. Carrilho, A. W. Martinez, G. M. Whitesides, Anal Chem., 81, 7091 (2009)

### SUMMARY OF INVENTION

### Technical Problem

An object of the present invention is to provide a fluidic device capable of realizing a flow at a stable flow velocity. Another object of the present invention is to provide a fluidic device capable of suppressing evaporation of a sample liquid.

Yet another object of the present invention is to provide a thermal transfer medium for fluidic device fabrication used for fabrication of a fluidic device of the present invention.

### Solution to Problem

In a first embodiment, a fluidic device of the present invention as a solution to the problems described above includes:

a base member;

a porous layer provided over the base member;

a flow path wall provided in the porous layer, and

a flow path defined by an inner surface of the flow path wall and the base member,

wherein linearity of the fluidic device is 30% or less, where the linearity is obtained by the following formula:

Linearity (%)={[A (mm)−B (mm)]/B (mm)}×100, and

wherein a length B is a length of a straight line between arbitrary two points on a contour of the inner surface of the flow path wall, and a length A is a length of a continuous line between said two points.

In a second embodiment, a fluidic device of the present invention includes a flow path that is enclosed by:

a base member;

a porous layer provided over the base member;

a flow path wall provided in the porous layer; and

a protection layer provided over the porous layer,

wherein the flow path wall and the protection layer are made of a thermoplastic material and fused with each other.

### Advantageous Effects of Invention

The present invention can provide a fluidic device capable of realizing a flow at a stable flow velocity. The present invention can also provide a fluidic device capable of suppressing evaporation of a sample liquid.

### BRIEF DESCRIPTION OF DRAWINGS

FIG. 1A is a schematic cross-sectional diagram showing an example layer structure of a thermal transfer medium for fluidic device fabrication of the present invention.

FIG. 1B is a schematic cross-sectional diagram showing an example layer structure of a thermal transfer medium for fluidic device fabrication.

FIG. 2 is a diagram showing a thermal transfer medium for fluidic device fabrication being placed over a porous layer over a base member.

FIG. 3 is an exemplary cross-sectional diagram showing an example fluidic device of the present invention.

FIG. 4A is a diagram showing an example flow path formed in a porous base member in an embodiment, where L1 is 30 mm, L2 is 5 mm, L3 is 2 mm, L4 is 7 mm, and L5 is 9 mm.

FIG. 4B is a diagram showing another example flow path formed in a porous base member in an embodiment, where L1 is 30 mm, L2 is 5 mm, L3 is 2 mm, L4 is 7 mm, and L5 is 9 mm.

FIG. 4C is a diagram showing another example flow path formed in a porous base member in an embodiment, where L1 is 30 mm, L2 is 5 mm, L3 is 2 mm, L4 is 7 mm, and L5 is 9 mm.

FIG. 4D is an exemplary cross-sectional diagram showing another example fluidic device of the present invention.

FIG. 5A is an exemplary cross-sectional diagram showing an example fluidic device of the present invention, where d1 is 125 μm.

FIG. 5B is an exemplary cross-sectional diagram showing another example fluidic device of the present invention, where d1 is 125 μM, d2 is 34 μm, and d3 is 89 μm.

FIG. 5C is an exemplary cross-sectional diagram showing another example fluidic device of the present invention, where d1 is 125 μm, d2 is 44 μm, and d3 is 73 μm.

FIG. 5D is an exemplary cross-sectional diagram showing another example fluidic device of the present invention, where d1 is 95 μm.

FIG. 5E is an exemplary cross-sectional diagram showing another example fluidic device of the present invention, where d1 is 125 μm, d2 is 12 μm, and d3 is 89 μm.

FIG. 5F is an exemplary cross-sectional diagram showing another example fluidic device of the present invention, where d1 is 125 μm, d2 is 23 μm, and d3 is 70 μm.

FIG. 6A is a plan diagram showing an example fluidic device of the present invention, where a is a sample addition region, b is a flow path, c is a reaction region, L1 is 30 mm, L2 is 5 mm, L3 is 2 mm, L4 is 7 mm, and L5 is 9 mm.

FIG. 6B is a plan diagram showing a state where a protection layer is provided over a flow path of FIG. 6A, where a is a sample addition region, b is a flow path, c is a reaction region, L1 is 30 mm, L2 is 5 mm, L3 is 2 mm, L4 is 7 mm, and L5 is 9 mm.

FIG. 7A is a diagram showing a state of a flow path wall having “no erosion” by a sample liquid.

FIG. 7B is a diagram showing a state of a flow path wall having “erosion” by a sample liquid.

FIG. 7C is a diagram showing a state of a flow path wall having “erosion” by a sample liquid.

FIG. 8 is a diagram showing a flow path formed in a fluidic device.

FIG. 9 is a diagram of an edge portion of a flow path in Comparative Example 4.

FIG. 10 is an image of FIG. 9 after image processing.

FIG. 11 is a diagram of an edge portion of a flow path in Example 1.

FIG. 12 is a diagram showing FIG. 11 after image processing.

FIG. 13 is an exemplary diagram showing how to obtain linearity of an inner surface of a flow path wall, where a length B is a length (mm) of a straight line between arbitrary two points on a contour of the inner surface of the flow path wall, and a length A is a length (mm) of a continuous line between the two points.

FIG. 14 is a diagram showing a state of a flow path wall formed in a porous layer of a fluidic device of an example.

FIG. 15 is a diagram showing a state of a flow path wall formed in a porous layer of a fluidic device of an example, where L11 is 5 mm, L12 is 17 m, L13 is 3 mm, L14 is 5 mm, L15 is 5 mm, L16 is 5 mm, L17 is 17 mm, L18 is 5 mm, and L19 is 17 mm.

FIG. 16A is a plan diagram showing an example fluidic device of the present invention, where L21 is 80 mm and L22 is 20 mm.

FIG. 16B is a diagram showing states where coloring liquids are let to flow in flow paths.

FIG. 17A is a cross-sectional diagram of the central diagram of FIG. 16B, where 2a is a flow path wall, 4 is a flow path, and 5 is a base member.

FIG. 17B is a cross-sectional diagram of the left-hand diagram of FIG. 16B, where 2a is a flow path wall, 4 is a flow path, and 5 is a base member.

FIG. 18 is a diagram showing an example flow path formed in a porous base member in an Example, where a is a sample addition region, b is a flow path, c is a reaction region, L1 is 30 mm, L2 is 5 mm, L3 is 2 mm, L4 is 7 mm, and L5 is 9 mm.

FIG. 19 is an exemplary cross-sectional diagram showing an example fluidic device of the present invention, where d1 is 125 μm.

FIG. 20 is a plan view showing a state of a protection layer being provided over the flow path of FIG. 18, where a is a sample addition region, b is a flow path, c is a reaction region, L1 is 30 mm, L2 is 5 mm, L3 is 2 mm, L4 is 7 mm, and L5 is 9 mm.

### DESCRIPTION OF EMBODIMENTS

### (Fluidic Device)

In a first embodiment, a fluidic device of the present invention includes a porous layer, a flow path wall provided in the porous layer, and a base material adjoining the porous layer and forming a flow path for a sample liquid together with the flow path wall, and includes other members according to necessity.

In a second embodiment, a fluidic device of the present invention includes a flow path enclosed by a base member, a porous layer formed over the base member, a flow path wall provided in the porous layer, and a protection layer provided over the porous layer, with the flow path wall and the protection layer made of a thermoplastic material and fused with each other, and includes other members according to necessity.

The fluidic device is not particularly limited and may be appropriately selected according to the purpose. Examples thereof include biosensors (sensing chips) for blood testing and DNA testing, small-size analytical devices for quality controls of foods and beverages, and various microfluidic devices.

When used as a biosensor, the fluidic device detects a detection target component by the principle of chromatography. In the fluidic device, a fluid is a mobile phase, and the porous layer is a stationary phase. Interactions between the stationary phase and substances allow a mixture to be separated and detected. The flow path wall conveys the detection target component to the reaction region without adsorbing it.

By forming a flow path wall in the porous layer by filling the porous layer with a thermoplastic material in order for the flow path wall to define a flow path, it is possible to provide a fluidic device free from liquid leakage, excellent in safety, inexpensive, and disposable.

One of the materials suitable for the porous layer of the fluidic device is paper. Paper is advantageous because it is inexpensive, easy to handle, excellent in portability as it is thin and lightweight, safely disposable, suitable for applications in which device disposability is required, and does not require an external actuator such as a pump because a sample liquid will flow through paper by a capillary action.

The flow path wall is usually formed by bonding a flow path forming material layer of a thermal transfer medium for fluidic device fabrication to a porous layer by thermal compression, and filling the voids in the porous layer with the flow path forming material layer that is melted. In the porous layer, regions other than the flow path are partially or completely covered or filled with the flow path wall. The flow path wall that is formed as the result of the voids in the porous layer being filled with the melted flow path forming material layer in this way can form a flow path that can repel a liquid, trap the liquid in a target (base member) region (that has not received transfer, for example), and let flow the sample liquid by a capillary action of the porous layer.

A thermal transfer printer is suitably used for fabrication of a fluidic device that meets these requirements. A flow path forming material layer of a thermal transfer medium for fluidic device fabrication used in the thermal transfer printer contains a thermoplastic material, and the content of the thermoplastic material is greater than in an ink layer of a common thermal transfer recording medium. The thermoplastic material easily penetrates into paper when thermally transferred because it has a very low melt viscosity when melted, and after melted (after filled), exhibits hydrophobicity because it is water-insoluble.

An inkjet printer does not contact the paper when printing, whereas a thermal transfer printer transfers a flow path wall into the porous layer by heat and pressure via the thermal transfer medium for fluidic device fabrication. Therefore, the thermal transfer method can also physically let the melted flow path forming material layer penetrate into the paper.

Moreover, the thermal transfer printer can run on a power source of a dry cell level, and is so small-sized as can be carried with a single hand and highly mobile. In this regard, this technique surpasses conventional inkjet printers and wax printers, and can provide an on-demand fluidic device for places where it is difficult or impossible to secure a power source.

In a fluidic device of a first embodiment of the present invention, linearity of a continuous line of the contour of the inner surface of the flow path wall is 30% or less, preferably 15% or less, and more preferably 10% or less.

By making the linearity 30% or less, it is possible to prevent a turbulent flow from occurring in the fluid flowing in the flow path, and to suppress degradation of the detection sensitivity due to slowdown of the flow velocity, etc.

How to obtain the linearity will now be explained.

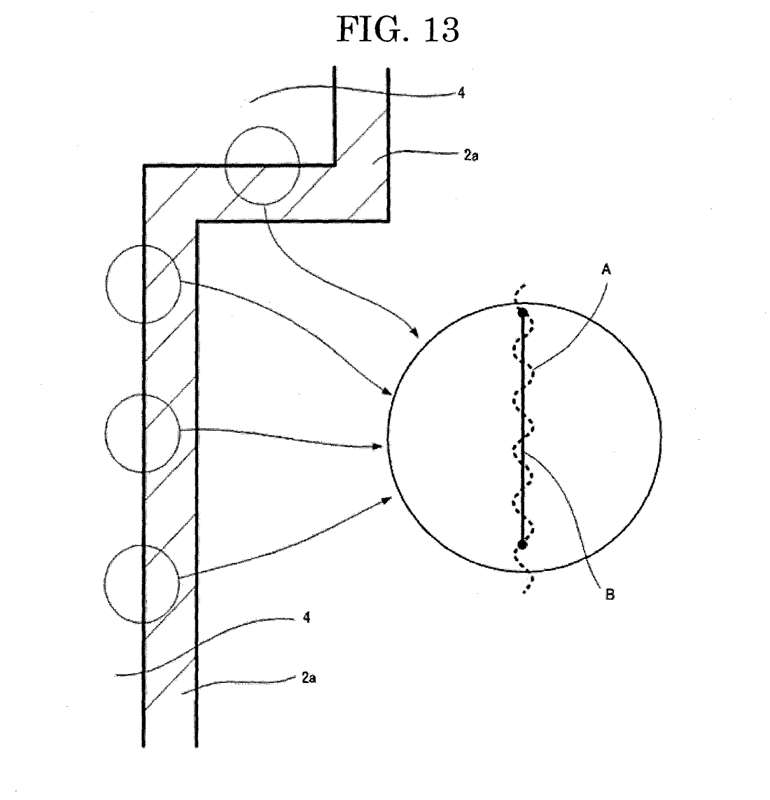

(1) A coloring liquid is let to flow in the flow path, and in a colored state, a portion of the flow path wall in an arbitrary range is imaged. Imaging may be performed by, for example, using an optical microscope, but is not limited to this. It is preferable to obtain an image of a viewing field of at least 10 mm×10 mm. The resolution of an image used for image analysis is preferably 20 dots/mm or greater, and more preferably 40 dots/mm or greater.
(2) The obtained image is analyzed with an image analyzing software program to measure the length A (mm) of a continuous line of the contour of the inner surface of the flow path wall. The length A (mm) of a continuous line of the contour is used as an actually measured value of a length B of a straight line between arbitrary two points on the contour (see FIG. 13). The length B of the straight line between the arbitrary two points is preferably 10 mm or longer.
(3) The length A of a continuous line of the contour is measured from arbitrary ten regions, and the average of the measured values is calculated. The values are substituted in the following formula to calculate the linearity (%).

Linearity (%)={[A (mm)−B (mm)]/B (mm)}×100

A specific example of calculating the linearity will be explained below.

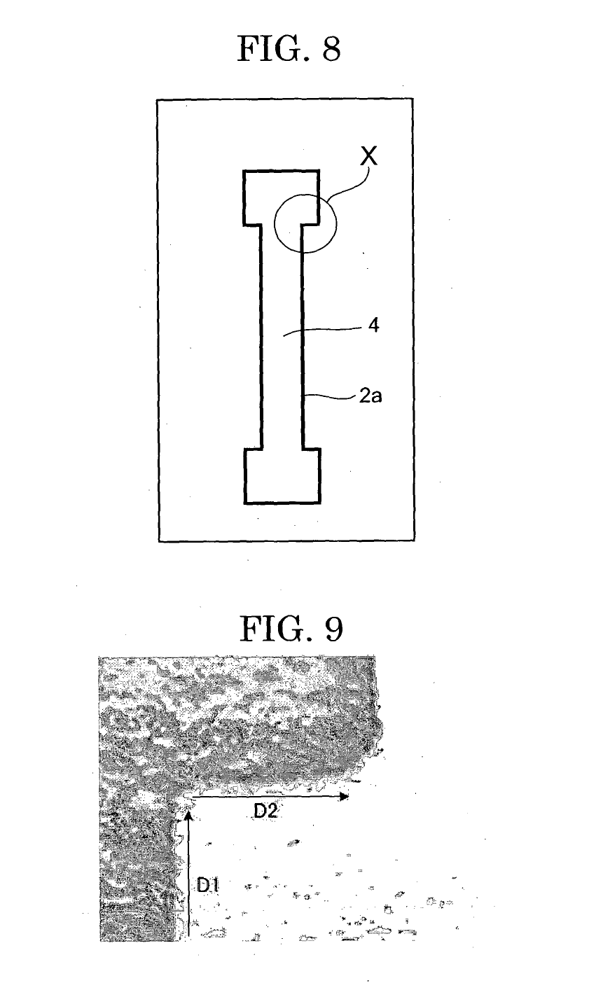

A flow path 4 shown in FIG. 8 is formed in a porous layer of a fluidic device, and a 0.07% by mass aqueous solution of a red pigment (CARMINE RED KL-80 manufactured by Kiriya Chemical Co., Ltd.) is let to flow in the flow path in order to clarify the boundary between the flow path 4 and a flow path wall 2a in an edge portion (indicated by X in FIG. 8). FIG. 9 shows a stained flow path of a fluidic device of Comparative Example 4, in which the flow path is formed with an UV ink with an inkjet printer. FIG. 11 shows a flow path of a fluidic device of Example 1 stained in the same manner. It has been confirmed that both of the flow paths are stained completely.

Next, with an optical microscope (DIGITAL MICROSCOPE VHX-1000 manufactured by Keyence Corporation), the stained flow path is enlarged at a magnification of ×100, and is recorded in the form of a digital image.

The resolution of the digital image is 40 dots/mm, and the viewing field is 30 mm×30 mm. However, these are not limited to these values.

The obtained digital image is processed with an image processing software program (IMAGE J; free software). The image processing software is not particularly limited and may be appropriately selected according to the purpose.

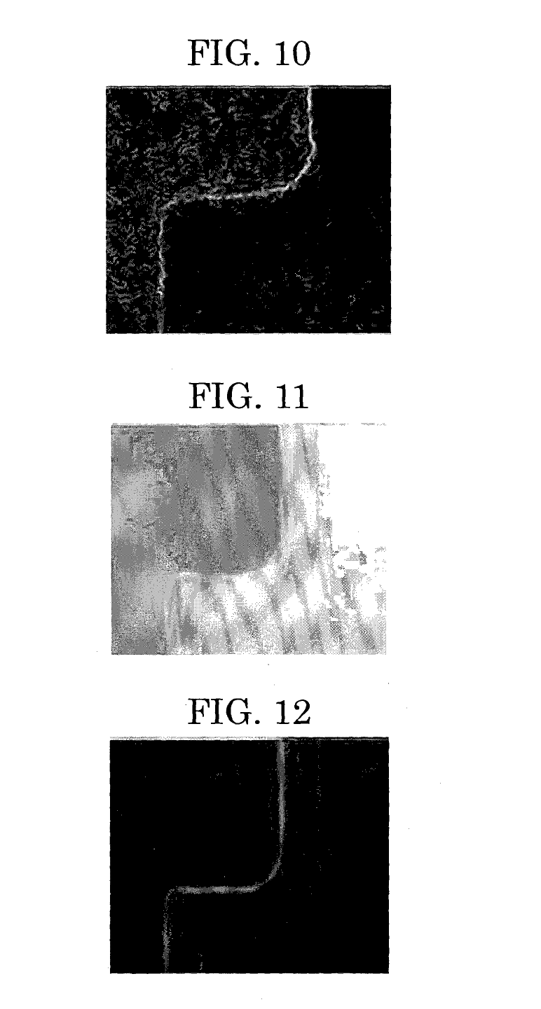

Next, an edge emphasizing process (a Find Edge command) is executed to further clarify the boundary between the flow path 4 and the flow path wall 2a. The resulting image of Comparative Example 4 is shown in FIG. 10, and the same for Example 1 is shown in FIG. 12.

In Comparative Example 4, the UV ink coated for forming the barrier spreads in the surface of the porous layer non-uniformly in the linear portion of the edge as shown in FIG. 10. This makes the boundary between the flow path 4 and the flow path wall 2a non-linear (undulated) in a top view, and a linearity failure is confirmed. Meanwhile, in Example 1, it can be seen that the boundary between the flow path 4 and the flow path wall 2a is linear as shown in FIG. 12.

Next, with the images of FIG. 10 and FIG. 12, the length A of a continuous line of the contour corresponding to a straight line that is between arbitrary two points on the contour and has a length B of 10 mm is measured in a main-scanning direction D1 and a sub-scanning direction D2 of the inner surface of the flow path wall. A line segment distance measurement (a Perimeter command) of the image processing software program (IMAGE J) is used for the measurement of the length A of a continuous line of the contour. In Comparative Example 4 shown in FIG. 10, the length A of a continuous line of the contour corresponding to the straight line that is between the arbitrary two points on the contour and has the length B (10 mm) is 14.2 mm in the main-scanning direction D1 of the flow path wall and 15.6 mm in the sub-scanning direction D2 of the flow path wall. In Example 1 shown in FIG. 12, the length A of a continuous line of the contour corresponding to the straight line that is between the arbitrary two points on the contour and has the length B (10 mm) is 10.4 mm in the main-scanning direction D1 of the flow path wall and 10.6 mm in the sub-scanning direction D2 of the flow path wall.

Here, the linearity (%) of a continuous line of the contour of the inner surface of the flow path wall can be calculated according to Linearity (%)={[A (mm)−B (mm)]/B (mm)}×100. The linearity is an average obtained by measuring ten different measurement positions as shown in FIG. 13, and averaging the obtained measurement values.

In Comparative Example 4, the linearity in the main-scanning direction D1 is 42% (=(14.2−10)/10×100), and the linearity in the sub-scanning direction D2 is 56% (=(15.6−10)/10×100).

In Example 1, the linearity in the main-scanning direction D1 is 4% (=(10.4−10)/10×100), and the linearity in the sub-scanning direction D2 is 6% (=(10.6−10)/10×100).

A linearity closer to 0% indicates that the inner surface of the flow path wall is more linear (has a greater linearity). A larger linearity indicates that the inner surface of the flow path wall has more undulations and a less linearity.

The flow velocity of the porous layer of the fluidic device is controlled by the principle of paper chromatography. In the paper chromatography, it is an ideal that the flow velocity of a mobile phase moving through the voids of the adsorbent (the porous layer) is uniform throughout a plane perpendicular to the direction of the flow. Non-uniformity of the flow velocity gives rise to distortion to the adsorption band, leading to degradation of separative power (‘Thin-layer chromatography—basics and applications—’, pp. 6-7, Masayuki Ishikawa, Nanzando Co., Ltd., 1963). Therefore, when the linearity of the inner surface of the flow path wall of the fluidic device in which a sample liquid flows is low as in Comparative Example 2, a turbulent flow occurs in the sample liquid, and the flow velocity of the sample liquid consequently slows down, which may degrade the sensitivity.

In the fluidic device of the second embodiment of the present invention, the flow path wall and the protection layer are made of a thermoplastic material and fused with each other. Hence, a flow path of a tubular shape can be formed enclosed by the base member, the flow path wall, and the protection layer, which improves the airtightness of the flow path.

### <Porous Layer>

The porous layer may be hydrophilic or hydrophobic, and may be appropriately selected in regard to the sample liquid to be used. However, a porous layer having hydrophilicity and a high voidage is preferably used.

The porous layer is a porous layer into which an aqueous solution can easily penetrate. A material can be said to be easily penetrable when in a test for water penetrability evaluation, a plate-shaped test piece of the material is dried for 1 hour at 120° C., pure water (0.01 mL) is dropped down onto the surface of the dried test piece, and the pure water (0.01 mL) completely penetrates into the test piece within 10 minutes.

The voidage of the porous layer is not particularly limited and may be appropriately selected according to the purpose. However, it is preferably from 40% to 90%, and more preferably from 65% to 80%. When the voidage is greater than 90%, the porous layer may not be able to keep the strength to qualify as the base member. When the voidage is less than 40%, the penetrability of the sample liquid may be poor.

The voidage is calculated according to the following calculation formula 1, based on the basis weight (g/m²) and the thickness (μm) of the porous layer, and the specific gravity of the component thereof.

Voidage (%)={1−[basis weight (g/m²)/thickness (μm)/specific gravity of the component]}×100 [Calculation Formula 1]

The porous layer is not particularly limited and appropriately selected according to the purpose. Examples thereof include filter paper, regular paper, high-quality paper, watercolor paper, Kent paper, synthetic paper, synthetic resin film, special-purpose paper having a coating, fabric, fiber product, film, inorganic substrate, and glass.

Examples of the fabric include artificial fiber such as rayon, bemberg, acetate, nylon, polyester, and vinylon, natural fibers such as cotton and silk, blended fabric of those above, and non-woven fabric of those above.

Among these, filter paper is preferable because it has a high voidage and a favorable hydrophilicity. When the fluidic device is used as a biosensor, the filter paper is preferable as the stationary phase of the paper chromatography.

The shape and average thickness of the porous layer are not particularly limited and may be appropriately selected according to the purpose. However, the porous layer is preferably a sheet-shaped. The average thickness of the porous layer is not particularly limited and may be appropriately selected according to the purpose. However, it is preferably from 0.01 mm to 0.3 mm. When the average thickness is less than 0.01 mm, the porous layer may not be able to keep the strength to qualify as the base member. When the average thickness is greater than 0.3 mm, great energy needs to be applied for filling the voids in the porous layer with a melted flow path wall, which may increase the power consumption.

### <Flow Path Wall>

The flow path wall contains a thermoplastic material, preferably contains an organic fatty acid and a long-chain alcohol, and further contains other components appropriately selected according to the purpose.

### <<Thermoplastic Material>>

The thermoplastic material is not particularly limited and may be appropriately selected according to the purpose, as long as it has durability enough to be kept from being easily structurally collapsed when the fluidic device is impregnated with water. Preferable examples thereof include at least one selected from the group consisting of fat and oil, and thermoplastic resin.

### —Fat and Oil—

The fat and oil means fat, fatty oil, and glazing material that are solid at normal temperature.

The fat and oil is not particularly limited and may be appropriately selected according to the purpose. Examples thereof include carnauba wax, paraffin wax, microcrystalline wax, paraffin oxide wax, candelilla wax, montan wax, ceresin wax, polyethylene wax, polyethylene oxide wax, castor wax, beef tallow hardened oil, lanolin, Japan tallow, sorbitan stearate, sorbitan palmitate, stearyl alcohol, polyamide wax, oleylamide, stearylamide, hydroxystearic acid, natural ester wax, synthetic ester wax, synthetic alloy wax, and sunflower wax.

One of these may be used alone, or two or more of these may be used in combination. Among these, candelilla wax and ester wax are preferable because they are excellent in thermal transferability when forming a flow path wall.

### —Thermoplastic Resin—

The thermoplastic resin is not particularly limited and may be appropriately selected according to the purpose. Examples thereof include polyolefin such as polyethylene and polypropylene, and polyamide-based resin such as polyethylene glycol, polyethylene oxide, acrylic resin, polyester resin, ethylene-vinyl acetate copolymer, ethylene-acrylate copolymer, urethane resin, cellulose, vinyl chloride-vinyl acetate copolymer, petroleum resin, rosin resin, nylon, and copolymer nylon. One of these may be used alone or two or more of these may be used in combination.

The thermoplastic material may be used as it is, but is preferably contained in the form of an emulsion together with organic fatty acid and long-chain alcohol. In this case, when the emulsion is heated by a thermal head, separation preferentially occurs at the boundary between the particles forming the emulsion, to break away the particles and transfer them into the surface of the porous layer. Therefore, the edge portions of the thermal transfer medium for fluidic device fabrication become sharp. Further, because the thermoplastic material emulsion is aqueous, it is advantageous in terms of low environmental impact.

The method for forming an aqueous emulsion of the thermoplastic material is not particularly limited and may be appropriately selected according to the purpose. Examples include a method of emulsifying the thermoplastic material by adding an organic fatty acid and an organic base to water and using the produced salt as an emulsifying agent.

The melting start temperature of the thermoplastic material is not particularly limited and may be appropriately selected according to the purpose. However, it is preferably from 50° C. to 150° C., and more preferably from 60° C. to 100° C. When the melting start temperature is lower than 50° C., storage stability under high temperature conditions may be poor. When it is higher than 150° C., transferability when performing thermal transfer may be poor.

Here, the melting start temperature of the thermoplastic material means a flowing start temperature that is confirmed by hardening the thermoplastic material, introducing it into a cylinder-shaped vessel having an opening of a diameter of 0.5 mm in the bottom, setting the vessel on an elevated flow tester (product name: SHIMADZU FLOW TESTER CFT-100 D manufactured by Shimadzu Corporation), raising the temperature of the sample at a constant rate of 5° C./min under a load of a cylinder pressure of 980.7 kPa, and measuring the melt viscosity and flow properties of the sample due to the temperature rise.

The content of the thermoplastic material in the flow path wall is not particularly limited and may be appropriately selected according to the purpose. However, it is preferably 75% by mass or greater. When the content is less than 75% by mass, the sensitivity of the flow path wall to heat may be poor.

### —Organic Fatty Acid—

The organic fatty acid is not particularly limited and may be appropriately selected according to the purpose. However, an organic fatty acid that has a predetermined acid value and a predetermined melting point is preferably used.

The acid value of the organic fatty acid is not particularly limited and may be appropriately selected according to the purpose. However, it is preferably from 90 mgKOH/g to 200 mgKOH/g, and more preferably from 140 mgKOH/g to 200 mgKOH/g. When the acid value is less than 90 mgKOH/g, the organic fatty acid may not be able to make the thermoplastic material an emulsion. When the acid value is greater than 200 mgKOH/g, the organic fatty acid is able to make the thermoplastic material an emulsion, but may make the emulsion creamy. Therefore, the resulting thermoplastic material may not be used as a coating liquid.

The organic fatty acid having the acid value described above is not particularly limited and may be appropriately selected according to the purpose. Examples thereof include oleic acid (with an acid value of 200 mgKOH/g), behenic acid (with an acid value of 160 mgKOH/g), and montanic acid (with an acid value of 132 mgKOH/g).

The acid value can be measured by, for example, dissolving the sample in a mixture solution of toluene, isopropyl alcohol, and a small amount of water, and titrating the resulting sample in a potassium hydroxide solution.

The melting point of the organic fatty acid is not particularly limited and may be appropriately selected according to the purpose. However, it is preferably from 70° C. to 90° C. When the melting point is within the preferable value range, it is close to the melting start temperature of the thermoplastic material, which makes the sensitivity property preferable. When the melting point is lower than 70° C., the flow path wall may be softened under high temperature conditions such as summertime.

The organic fatty acid having the melting point described above is not particularly limited and may be appropriately selected according to the purpose. Examples thereof include behenic acid (with a melting point of 76° C.) and montanic acid (with a melting point of 80° C.).

The melting point can be measured by using a differential scanning calorimeter “DSC7020” (manufactured by Seiko Instruments, Inc.) and measuring the temperature at which a crystal melting endothermic peak that is to appear in a temperature raising measurement with the differential scanning calorimeter ends.

The content of the organic fatty acid in the flow path wall is not particularly limited and may be appropriately selected according to the purpose. However, it is preferably from 1 part by mass to 6 parts by mass relative to 100 parts by mass of the thermoplastic material. When the content is less than 1 part by mass, the organic fatty acid may not be able to make the thermoplastic material an emulsion. When the content is greater than 6 parts by mass, blooming of the thermoplastic material may occur.

### —Long-Chain Alcohol—

The long-chain alcohol is not particularly limited and may be appropriately selected according to the purpose. However, at least one selected from a long-chain alcohol represented by General Formula (1) below and a long-chain alcohol represented by General Formula (2) below is preferable.

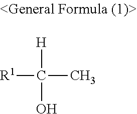

In General Formula (1) above, R¹ represents alkyl group having 28 to 38 carbon atoms.

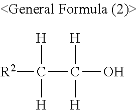

In General Formula (2) above, R² represents alkyl group having 28 to 38 carbon atoms.

The long-chain alcohol is not particularly limited and may be appropriately selected according to the purpose. However, it is preferably aliphatic alcohol having a melting point of from 70° C. to 90° C. When the melting point is lower than 70° C., the flow path wall may be softened under high temperature conditions such as summertime. When the melting point is higher than 90° C., the transferability of the flow path wall may be poor. When the melting point is within the preferable value range, it is close to the melting start temperature of the thermoplastic material, which makes the transferability of the flow path wall preferable.

The melting point can be measured by the same method for measuring the melting point of the organic fatty acid.

The long chain of the long-chain alcohol may be composed only of a straight chain, or may have branched chains. The number of carbon atoms on the long chain (the number of carbon atoms in the alkyl group) is not particularly limited and may be appropriately selected according to the purpose. However, it is preferably from 28 to 38.

When the number of carbon atoms is out of the above value range, blooming may occur on the surface of the flow path wall along with the elapse of time, and may contaminate the surface of a back layer when the thermal transfer medium for fluidic device fabrication is stored in a rolled shape.

The content of the long-chain alcohol in the flow path wall is not particularly limited and may be appropriately selected according to the purpose. However, it is preferably from 6 parts by mass to 12 parts by mass relative to 100 parts by mass of the thermoplastic material.

When the content is less than 6 parts by mass, the blooming suppression effect may not be obtained. When the content is greater than 12 parts by mass, the transferability of the flow path wall may be poor when there is a temperature difference from the melting start temperature of the thermoplastic material.

### <Other Components>

The other components are not particularly limited and may be appropriately selected according to the purpose. Examples thereof include organic base, non-ionic surfactant, and coloring agent.

### —Organic Base—

The organic base may be used in combination with the organic fatty acid when emulsifying the thermoplastic material.

The organic base is not particularly limited and may be appropriately selected according to the purpose. However, morpholine is preferable because it easily volatilizes after dried.

The content of the organic base in the flow path wall is not particularly limited and may be appropriately selected according to the purpose. However, it is preferably from 0.5 parts by mass to 5 parts by mass relative to 100 parts by mass of the thermoplastic material.

### —Non-Ionic Surfactant—

Addition of the non-ionic surfactant enables the aqueous emulsion of the thermoplastic material to have a small particle diameter, which improves the cohesive force of the flow path wall and enables prevention of a background smear.

The non-ionic surfactant is not particularly limited and may be appropriately selected according to the purpose. Examples thereof include POE oleylether.

The content of the non-ionic surfactant in the flow path wall is not particularly limited and may be appropriately selected according to the purpose. However, it is preferably from 2 parts by mass to 7 parts by mass relative to 100 parts by mass of the thermoplastic material. When the content is less than 2 parts by mass, the effect of making the particle diameter of the emulsion of the thermoplastic material small may be poor when making an aqueous emulsion of the thermoplastic material. When the content is greater than 7 parts by mass, the flow path wall may become soft to degrade the friction resistance of the formed flow path wall.

### —Coloring Agent—

The coloring agent may be added in order to impart the capability for the flow path wall to be distinguished in the porous layer.

The coloring agent is not particularly limited and may be appropriately selected according to the purpose. Examples thereof include carbon black, azo-based pigment, phthalocyanine, quinacridone, anthraquinone, perylene, quinophthalone, aniline black, titanium oxide, zinc oxide, and chromium oxide. Among these, carbon black is preferable.

The content of the coloring agent in the flow path wall is not particularly limited and may be appropriately selected according to the purpose. However, it is preferably from 0.5 parts by mass to 5 parts by mass relative to 100 parts by mass of the thermoplastic material.

The flow path wall may be formed directly into the porous layer, but is preferably formed by being thermally transferred thereinto with the use of the thermal transfer medium for fluidic device fabrication described later.

Thermal transferring of the flow path wall into the porous layer enables the voids in the porous layer to be filled with the flow path wall that is melted, resulting in a flow path being formed in the porous layer.

The shape of the flow path wall is not particularly limited and may be appropriately selected according to the purpose. Examples thereof include one of a straight line, a curve, and a junction of plural branches, or combinations of these. Furthermore, it may also be possible to form a flow path that is enclosed by the flow path wall so as to make a sample solution stay within a predetermined region for a specific mixing and a specific reaction.

The width of the flow path wall is not particularly limited, and patterning may be applied with an arbitrary width according to the size of the fluidic device. However, the width is preferably 500 μm or greater. When the width of the flow path wall is less than 500 μm, filling of the voids in the porous layer may be insufficient, which may make the flow path wall unable to function as a liquid-impenetrable barrier.

The flow path wall may be formed to have an arbitrary length in the direction of thickness of the porous layer from the surface thereof into the interior thereof, i.e., in the direction of depth.

In terms of factors that control the length, the length can be controlled based on the melt viscosity and hydrophilicity of the fat and oil or the thermoplastic resin that is the thermoplastic material. The lower the melt viscosity, the easier it becomes for the flow path wall to penetrate into the interior of the porous layer from the surface thereof, which enables a long length. Conversely, the higher the melt viscosity, the harder it becomes for the flow path wall to penetrate into the interior of the porous layer from the surface thereof, which enables a substantially non-penetrated state. It is possible to control the thickness by controlling the melt viscosity.

Meanwhile, as for the hydrophilicity of the fat and oil, and the thermoplastic resin, ones with a higher hydrophilicity can more easily penetrate into the interior of the porous layer from the surface thereof, enabling a long length.

Conversely, ones with a lower hydrophilicity can more hardly penetrate into the interior of the porous layer from the surface thereof, enabling a substantially non-penetrated state. It is possible to control the thickness by controlling the hydrophilicity, but the melt viscosity influences the penetrability much more than the hydrophilicity does.

The melt viscosity varies depending also on the hydrophilicity of the material of the porous layer, i.e., the fat and oil or the thermoplastic resin.

Therefore, the value range of the melt viscosity to be mentioned below does not necessarily apply, but the thermoplastic material, if it is a porous material such as cellulose, can be freely selected from materials of a very broad viscosity range of from 3 mPa·s to 1,600 mPa·s, and can be thermally transferred. In particular, in order to make the thermoplastic material penetrate into the interior of the porous layer from the surface thereof so as to bring the thermoplastic material sufficiently close to the base member, it is preferable to use a thermoplastic material having a melt viscosity of from 6 mPa·s to 200 mPa·s.

Meanwhile, an inkjet printer using an ultraviolet curable resin ink jets the ink from the head and makes the ink droplets fly and land into the porous layer. Therefore, there is a limitation; in order for the liquid to be jetted from the head, the viscosity of the liquid needs to be as low as 15 mPa·s at the maximum, or needs actually to be lower than 10 mPa·s, or otherwise the liquid cannot be jetted from the head, which allows poor latitude for the material. For this reason, the ink that can be used in the inkjet printer has a very low viscosity, and hence easily spreads in the porous layer, making a large bleed.

The same can be said for a wax printer. A wax printer thermally fuses a dry ink and jets the ink from the head to make droplets of the melted ink fly and land into the porous layer. Therefore, there is the same viscosity limitation as described above, in order for the ink to be jetted from the head, resulting in a poor latitude for the material. Besides, in the case of a wax printer, in reality, the temperature of the dry ink lowers during the flight to thereby make the viscosity have already risen above the level at which the ink can penetrate into the porous layer when the ink droplets land on the porous layer. Therefore, the ink droplets stop on the surface of the porous layer and cannot penetrate into the interior of the porous layer. This indispensably necessitates a step of heating the porous layer to a temperature at which the thermoplastic material can melt sufficiently in order to make the material penetrate. Therefore, not only does the process become complicated, but it cannot be helped that the porous layer must be entirely heated, which makes it easier for the ink to spread also in the horizontal direction, making a large bleed.

In contrast, the thermal transfer system performs printing by bringing the thermal head into direct contact with the porous layer via the thermal transfer medium for fluidic device fabrication. Therefore, the thermal head applies heat only locally to a minute portion to which to transfer the ink, which enables effective suppression of the spreading of the thermoplastic material in the horizontal direction, resulting in a highly linear flow path with no bleed.

The length can also be controlled by controlling the energy to be applied for thermal compression bonding. That is, the more the energy to be applied is increased to raise the temperature of the fat and oil, and the thermoplastic resin, which are the thermoplastic material, the more inward they penetrate, whereas the more the temperature is lowered, the closer to the surface they stop.

By increasing the melt viscosity of the fat and oil, and the thermoplastic resin, by reducing the hydrophilicity, or by reducing the energy to be applied for thermal compression bonding, it is possible to make it harder for the flow path wall to penetrate into the interior of the porous layer from the surface thereof, or to leave the flow path wall substantially non-penetrated. Utilizing this effect, it is possible to form the flow path wall over the surface of the porous layer in the direction of the thickness thereof. That is, it is possible to form a flow path wall thick over the surface of the porous layer, by increasing the amount of the fat and oil, and the thermoplastic resin to be thermally transferred. On the other hand, it is possible to form a flow path wall thinner by reducing the amount of the fat and oil, and the thermoplastic resin to be thermally transferred. The amount of thermal transfer can be controlled by increasing or reducing the energy to be applied for thermal compression bonding or by increasing or reducing the thickness of the flow path wall of the thermal transfer medium for fluidic device fabrication.

### <Flow Path>

The flow path to be defined in the porous layer by the flow path wall is not particularly limited and may be appropriately selected according to the purpose, as long as it includes at least a sample addition region, a reaction region, and a detection region.

The sample addition region is a region to which a sample liquid is added, and the circumference of the opening that defines the region is preferably provided with a protrusion that protrudes above the porous layer. This can prevent the leakage of the sample liquid to the outside, and can allow the sample liquid to be added in a large amount.

The protrusion may be formed by the protection layer, but may be formed by a sealing member.

The reaction region is a region in which the sample liquid is let to react with a marker so as to be detected.

The detection region is a region at which it is confirmed that the sample liquid has flowed into the reaction region sufficiently.

### <Base Member>

The shape, structure, size, material, etc. of the base member are not particularly limited and may be appropriately selected according to the purpose. Examples of the shape include a film shape and a sheet shape.

The average thickness of the base member is preferably from 0.01 mm to 0.5 mm. When the average thickness is less than 0.01 mm, the base member may not be able to keep the strength to qualify as the base member. When the average thickness is greater than 0.5 mm, the flexibility may be poor depending on the material of the base member.

The average thickness of the base member is not particularly limited and may be appropriately selected according to the purpose. The average thickness may be the average of the thicknesses of 5×3=15 positions of the measurement target measured with a micrometer, where the 5 positions are selected in the longer direction of the measurement target at mostly constant intervals, and the 3 positions are selected in the shorter direction at mostly constant intervals.

Examples of the structure of the base member include a single-layer structure and a multi-layer structure. The size of the base member may be appropriately selected according to the purpose, etc.

The base member is preferably provided so as to overlap with at least the portion of the porous layer in which the flow path is to be formed, which enables prevention of liquid spill from the flow path.

The material of the base member is not particularly limited and may be appropriately selected according to the purpose. Examples thereof include polyester such as polyethylene terephthalate (PET) and polyethylene naphthalate (PEN), polycarbonate, polyimide resin (PI), polyamide, polyethylene, polypropylene, polyvinyl chloride, polyvinylidene chloride, polystyrene, styrene-acrylonitrile copolymer, and cellulose acetate. One of these may be used alone, or two or more of these may be used in combination. Among these, polyethylene terephthalate (PET) and polyethylene naphthalate (PEN) are particularly preferable.

### <Protection Layer>

The shape, structure, size, material, etc. of the protection layer are not particularly limited and may be appropriately selected according to the purpose. Examples of the shape include a film shape and a sheet shape. Examples of the structure include a single-layer structure and a multi-layer structure. The size thereof may be appropriately selected according to the purpose, etc.

The protection layer is preferably provided over at least a portion of the porous layer, or may be provided all over the porous layer. When providing the protection layer over a portion of the porous layer, it is preferable to provide it over the portion corresponding to the flow path. This can make the flow path a closed system and enables the sample liquid to be prevented from being dried. This can further prevent the sample liquid from adhering to a hand, which improves the safety.

The material of the protection layer is not particularly limited and may be appropriately selected according to the purpose. However, the same thermoplastic material as the flow path wall is preferably used. The protection layer can be formed by thermal transfer like the flow path wall.

The average thickness of the protection layer is not particularly limited and may be appropriately selected according to the purpose. However, it is preferably 100 μm or less.

With the average thickness of 100 μm or less, heat can be sufficiently conducted to the thermoplastic material constituting the flow path wall, to thereby enable favorable fusion between the thermoplastic material constituting the flow path wall and the thermoplastic material constituting the protection layer to get them favorably fused with each other.

### (Thermal Transfer Medium for Fluidic Device Fabrication)

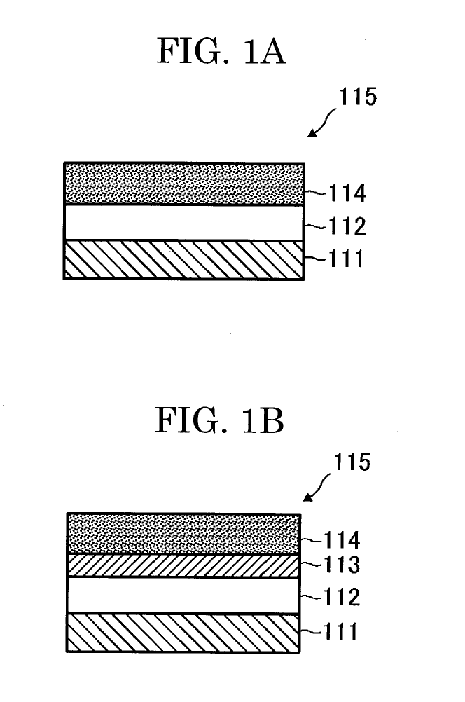

Next, a thermal transfer medium for fluidic device fabrication (one example of a fluidic device thermal transfer medium) will be explained with reference to FIG. 1A. FIG. 1A is a schematic diagram showing an example thermal transfer medium for fluidic device fabrication of the present invention. According to an embodiment of the present invention, a thermal transfer medium for fluidic device fabrication 115 includes at least a support member 112, and a flow path forming material layer 114 provided over the support member 112, in this order. The flow path forming material layer 114 contains a thermoplastic material that will penetrate into a porous layer when the flow path forming material layer 114 is thermally transferred to the porous layer (an example member having porosity). The thickness of the flow path forming material layer 114 is from 30 μM to 250 μM. Being provided over the support member 112 means being provided so as to contact the support member 112. The thermoplastic material penetrating into the porous layer means the voids constituting the porous layer being filled with the thermoplastic material by thermal transfer.

The thermal transfer medium for fluidic device fabrication 115 is used for fabrication of a fluidic device that is composed of a porous layer in which a flow path is formed.

A conventional thermal transfer recording medium for recording purposes (ink ribbon) includes a releasing layer between the support member and the flow path forming material layer, in order to improve the separability of the flow path forming material layer. Therefore, it is difficult for heat from a thermal head to be conducted to the flow path forming material layer. Hence, high energy is required for forming a flow path in a porous layer by using the conventional thermal transfer recording medium for recording purposes.

On the other hand, the thermal transfer medium for fluidic device fabrication of the present embodiment includes at least a flow path forming material layer containing a thermoplastic material over the support member. Therefore, it is easier for heat from a thermal head to be conducted to the flow path forming material layer when performing thermal transfer. Therefore, the flow path forming material layer can be transferred into the porous layer to the full depth in the thickness direction with less energy.

### <Support Member>

The shape, structure, size, material, etc. of the support member 112 are not particularly limited and may be appropriately selected according to the purpose. Examples of the structure include a single-layer structure and a multi-layer structure. The size may be appropriately selected according to the size of the thermal transfer medium for fluidic device fabrication 115.

The material of the support member 112 is not particularly limited and may be appropriately selected according to the purpose. Examples thereof include polyester such as polyethylene terephthalate (PET) and polyethylene naphthalate (PEN), polycarbonate, polyimide resin (PI), polyamide, polyethylene, polypropylene, polyvinyl chloride, polyvinylidene chloride, polystyrene, styrene-acrylonitrile copolymer, and cellulose acetate. One of these may be used alone, or two or more of these may be used in combination. Among these, polyethylene terephthalate (PET) and polyethylene naphthalate (PEN) are particularly preferable.

A surface activation treatment is preferably applied to the surface of the support member 112 in order to improve the close adhesiveness with the layer to be provided over the support member 112. Examples of the surface activation treatment include glow discharge treatment and corona discharge treatment.

The support member 112 may be kept after the flow path forming material layer 114 of the thermal transfer medium for fluidic device fabrication 115 is transferred into the porous layer, or the support member 112, etc. may be removed by being separated by means of the releasing layer 113 after the flow path forming material layer 114 is transferred.

The support member 112 is not particularly limited and may be an appropriately synthesized product or a commercially-available product.

The average thickness of the support member 112 is not particularly limited and may be appropriately selected according to the purpose. However, it is preferably from 3 μm to 50 μm.

### <Flow Path Forming Material Layer>

The method for forming the flow path forming material layer 114 is not particularly limited and may be appropriately selected according to the purpose. For example, as a hot-melt coating method or a coating method using a coating liquid obtained by dispersing the thermoplastic material in a solvent, a common coating method using a gravure coater, a wire bar coater, a roll coater, or the like may be used to coat the support member 112 or the releasing layer 113 with the flow path forming material layer coating liquid and dry the coating.

The average thickness of the flow path forming material layer 114 is not particularly limited and may be appropriately selected according to the purpose. However, it is preferably from 30 μm to 250 μm. When the average thickness is less than 30 μm, the amount of the flow path forming material layer 114 may be insufficient for filling the voids in the porous layer. When the average thickness is greater than 250 μm, it becomes harder for heat from the thermal head to be conducted to the flow path forming material layer 114, to thereby degrade the transferability. When the thickness of the flow path (or the height of the flow path wall) of a fluidic device is 30 μm or greater or preferably 50 μm or greater, it is hard for a liquid flowing through the flow path such as a testing liquid to evaporate, and a sufficient detection sensitivity can be achieved. Further, when the thickness of the flow path (or the height of the flow path wall) of a fluidic device is 250 μm or less or preferably 120 μm or less, the required amount of a liquid such as a testing liquid will not be too large. In order for a flow path wall having such a thickness to be formed, the average thickness of the flow path forming material layer 114 is preferably from 30 μm to 250 μm, and particularly preferably from 50 μm to 120 μm. This is preferable because the flow path wall can be formed without any excessiveness or shortage of the thermoplastic material to be used. In the present embodiment, the average thickness is not particularly limited, but may be the average of the thicknesses of 5×3=15 positions of the measurement target measured with a micrometer, where the 5 positions are selected in the longer direction of the measurement target at mostly constant intervals, and the 3 positions are selected in the shorter direction at mostly constant intervals. Further, in the present embodiment, the thickness of the flow path forming material layer 114 may be the length of the measurement target that is measured in a direction perpendicular to the contact plane between the releasing layer 113 and the flow path forming material layer 114.

The amount of deposition of the flow path forming material layer 114 is not particularly limited and may be appropriately selected according to the purpose. However, it is preferably from 30 g/m² to 250.0 g/m², and more preferably from 50 g/m² to 120.0 g/m².

The melt viscosity of the thermoplastic material constituting the flow path forming material layer 114 is preferably fro 3 mPa/sec to 1,600 mPa/sec, and more preferably from 6 mPa·s to 200 mPa·s as explained above regarding the material constituting the flow path wall. The method for measuring the melt viscosity is not particularly limited. Examples thereof include a measurement according to a testing method compliant with ISO11443. In the present embodiment, the melt viscosity was measured at 100° C., which corresponds to a temperature to be reached by the thermoplastic material by being heated by a head.

### <Other Layers and Members>

The other layers and members are not particularly limited and may be appropriately selected according to the purpose. Examples thereof include a releasing layer, a back layer, an undercoat layer, and a protection film.

### <Releasing Layer>

The thermal transfer medium of the present embodiment preferably does not include a releasing layer, in order to be able to efficiently conduct heat to the flow path forming material layer and perform printing with low energy. However, the thermal transfer medium may include a releasing layer, if the releasing layer has a very weak adhesiveness with the support member or if the thermoplastic material and the material constituting the releasing layer have close melt viscosities.

A case in which a releasing layer is provided in the thermal transfer medium for fluidic device fabrication will be explained below with reference to FIG. 1B.

FIG. 1B is a schematic diagram showing an example thermal transfer medium for fluidic device fabrication. In an embodiment of the present invention, the thermal transfer medium for fluidic device fabrication 115 includes at least a support member 112, a releasing layer 113 provided over the support member 112, and a flow path forming material layer 114 (an example flow path forming material layer) provided over the releasing layer 113, in this order.

The releasing layer 113 has a function of improving the separability between the support member 112 and the flow path forming material layer 114 when performing transfer. When heated by a heating/pressurizing means such as a thermal head, the releasing layer 113 thermally fuses to become a liquid having a low viscosity, to exert a function of facilitating separation of the flow path forming material layer 114 near the interface between a heated portion and a non-heated portion.

The releasing layer 113 contains wax and binder resin, and further contains other components appropriately selected according to necessity.

### —Wax—

The wax is not particularly limited and may be appropriately selected according to the purpose. Examples thereof include: natural wax such as beeswax, carnauba wax, spermaceti, Japan tallow, candelilla wax, rice wax, and montan wax; synthetic wax such as paraffin wax, microcrystalline wax, oxide wax, ozokerite, ceresin, ester wax, polyethylene wax, and polyethylene oxide wax; higher fatty acid such as margaric acid, lauric acid, myristic acid, palmitic acid, stearic acid, furoic acid, and behenic acid; higher alcohol such as stearin alcohol and behenyl alcohol; esters such as sorbitan fatty acid ester; and amides such as stearic amide and oleic amide. One of these may be used alone or two or more of these may be used in combination. Among these, carnauba wax and polyethylene wax are preferable because they are excellent in releasing ability.

### —Binder Resin—

The binder resin is not particularly limited and may be appropriately selected according to the purpose. Examples thereof include ethylene-vinyl acetate copolymer, partially saponified ethylene-vinyl acetate copolymer, ethylene-vinyl alcohol copolymer, ethylene-sodium methacrylate copolymer, polyamide, polyester, polyurethane, polyvinyl alcohol, methyl cellulose, carboxymethyl cellulose, starch, polyacrylic acid, isobutylene-maleic acid copolymer, styrene-maleic acid copolymer, polyacrylamide, polyvinyl acetal, polyvinyl chloride, polyvinylidene chloride, isoprene rubber, styrene-butadiene copolymer, ethylene-propylene copolymer, butyl rubber, and acrylonitrile-butadiene copolymer. One of these may be used alone, or two or more of these may be used in combination.

The method for forming the releasing layer 113 is not particularly limited and may be appropriately selected according to the purpose. Examples thereof include a hot-melt coating method, and a coating method using a coating liquid obtained by dispersing the wax and the binder resin in a solvent.

The average thickness of the releasing layer 113 is not particularly limited and may be appropriately selected according to the purpose. However, it is preferably from 0.5 μm to 2.0 μm.

The amount of deposition of the releasing layer 113 is not particularly limited and may be appropriately selected according to the purpose. However, it is preferably from 0.5 g/m² to 8 g/m², and more preferably from 1 g/m² to 5 g/m².

### —Back Layer—

The thermal transfer medium for fluidic device fabrication 115 preferably includes a back layer 111 over a side of the support member 112 opposite to the side over which the flow path forming material layer 114 is formed. The opposite side is directly heated by a thermal head or the like at a position corresponding to the flow path forming material layer 114. Therefore, the back layer 111 preferably has resistance to high heat and resistance to friction with a thermal head or the like. The back layer 111 contains a binder resin, and further contains other components according to necessity.

The binder resin is not particularly limited and may be appropriately selected according to the purpose. Examples thereof include silicone-modified urethane resin, silicone-modified acrylic resin, silicone resin, silicone rubber, fluororesin, polyimide resin, epoxy resin, phenol resin, melamine resin, and nitrocellulose. One of these may be used alone or two or more of these may be used in combination.

The other components are not particularly limited and may be appropriately selected according to the purpose. Examples thereof include inorganic particles of talc, silica, organopolysiloxane, etc., and lubricant.

The method for forming the back layer 111 is not particularly limited and may be appropriately selected according to the purpose. Examples thereof include common coating methods using a gravure coater, a wire bar coater, a roll coater, etc.

The average thickness of the back layer 111 is not particularly limited and may be appropriately selected according to the purpose. However, it is preferably from 0.01 μm to 1.0 μm.

### —Undercoat Layer—

An undercoat layer may be provided between the support member 112 and the flow path forming material layer 114, or between the releasing layer 113 provided over the support member 112 and the flow path forming material layer 114.

The undercoat layer contains a resin, and further contains other components according to necessity.

The resin is not particularly limited and may be appropriately selected according to the purpose. The resins used for the flow path forming material layer 114 and the releasing layer 113 can be used.

### —Protection Film—

It is preferable to provide a protection film over the flow path forming material layer 114 for protecting the layer from contamination or damages during storage.

The material of the protection film is not particularly limited and may be appropriately selected according to the purpose, as long as it can be easily separated from the flow path forming material layer 114. Examples thereof include silicone sheet, polyolefin sheet such as polypropylene sheet, and polytetrafluoroethylene sheet.

The average thickness of the protection film is not particularly limited and may be appropriately selected according to the purpose. However, it is preferably from 5 μm to 100 μm, and more preferably from 10 μm to 30 μm.

FIG. 1A is a schematic diagram showing an example thermal transfer medium for fluidic device fabrication of the present invention. The thermal transfer medium for fluidic device fabrication 115 shown in FIG. 1A includes a support member 112 and a flow path forming material layer 114 over the support member 112 in this order, and includes a back layer 111 over a surface of the support member 112 over which the flow path forming material later is not provided. A protection film (not shown) may be provided over the surface of the flow path forming material layer 114 according to necessity.

The thermal transfer medium for fluidic device fabrication of the present invention is not particularly limited and may be used for various purposes. However, it can preferably be used for a fluidic device of the present invention to be explained below and for fabrication method of the fluidic device.

### (Fabrication Method of Fluidic Device)

A fabrication method of a fluidic device of the present invention is a method for fabricating the fluidic device of the present invention.

In this method, a porous layer and the flow path forming material layer of the thermal transfer medium for fluidic device fabrication of the present invention are brought to face each other and overlap with each other, and bonded to each other by thermal compression, to thereby thermally transfer the flow path forming material layer of the thermal transfer medium for fluidic device fabrication into the porous layer to form a flow path in the porous layer.

Furthermore, the thermoplastic material may be again transferred as a protection layer onto the flow path by thermal energy, to thereby obtain a fluidic device having a flow path of a tubular shape that is enclosed by a base member, a flow path wall, and a protection layer.

The method for thermally transferring the thermal transfer medium for fluidic device fabrication is not particularly limited and may be appropriately selected according to the purpose. Examples thereof include a method of melting and transferring the flow path forming material layer by thermal compression bonding by a serial thermal head, a line thermal head, etc.

By printing both sides of the porous layer by thermal transfer, it is possible to form flow paths of different angles in the porous layer, making it possible to form a three-dimensional flow path pattern structure.

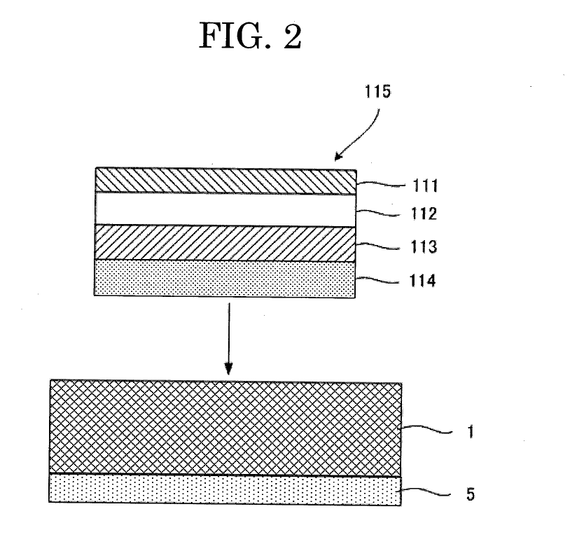

When there is provided a protection film over the flow path forming material layer 114 of the thermal transfer medium for fluidic device fabrication 115 shown in FIG. 1A, the protection film (not shown) is firstly removed, and as shown in FIG. 2, the flow path forming material layer 114 of the thermal transfer medium for fluidic device fabrication 115 is brought to face a porous layer 1 over a base member 5 to overlap with each other.

Next, thermal compression bonding is applied by a thermal head (not shown) to thermally transfer the flow path forming material layer 114 of the thermal transfer medium for fluidic device fabrication into the porous layer 1 to form a flow path in the porous layer 1.

Further, a protection layer may be formed over the flow path to thereby obtain a fluidic device having a flow path of a tubular shape that is enclosed by the base member, the flow path wall, and the protection layer.

The energy to be applied for thermal compression bonding is not particularly limited and may be appropriately selected according to the purpose. However, it is preferably from 0.05 mJ/dot to 1.30 mJ/dot, and more preferably from 0.1 mJ/dot to 1.00 mJ/dot.

When the energy is less than 0.05 mJ/dot, the flow path forming material layer may be melted insufficiently. When the energy is greater than 1.30 mJ/dot, an excessive heat is applied to the thermal head to cause problems that a wire in the head may be burned off or the properties of the porous layer may be altered.

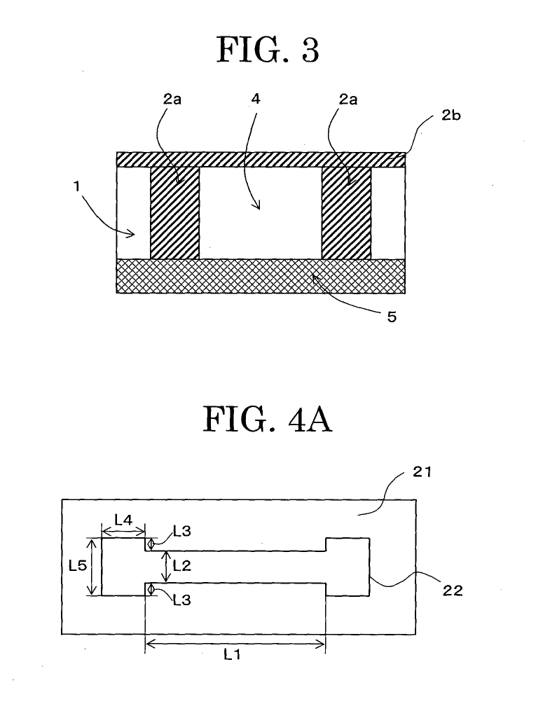

In this way, a fluidic device shown in FIG. 3, in which a flow path 4 is formed over a base member 5 by a porous layer 1, flow path walls 2a and 2a, and a protection layer 2b, is obtained.

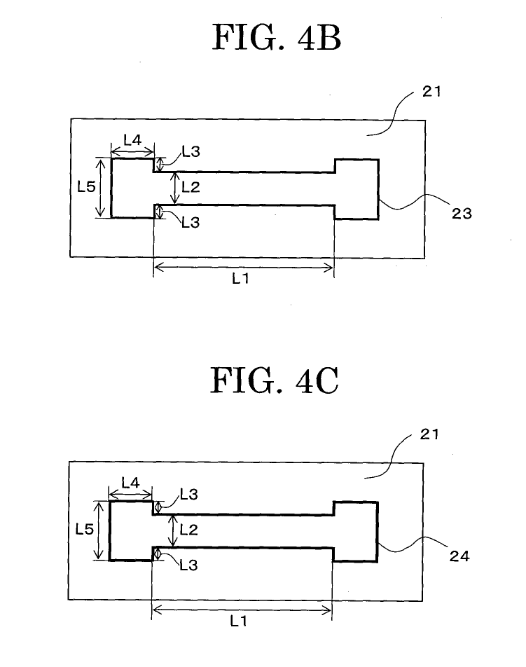

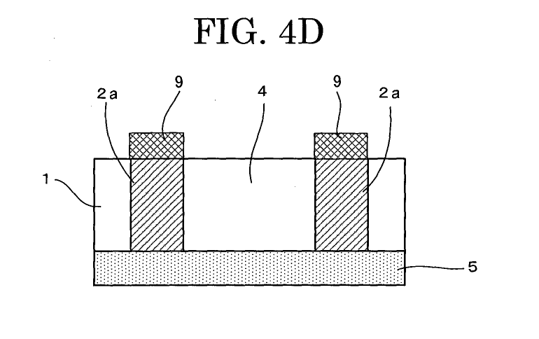

FIG. 4D shows a fluidic device in which protrusions 9 and 9 are provided instead of the protection layer 2b over the flow path walls 2a and 2a. The protrusions 9 and 9 may be made of the same material as the protection layer.

The fluidic device of the present invention is preferably used for sensing chips (microfluidic devices) in the fields of chemistry and biochemistry. The fluidic device is particularly preferably used in the field of biochemistry, because it is excellent in safety.

Samples used for testing in the field of biochemistry are not particularly limited and may be appropriately selected according to the purpose. Examples thereof include pathogen such as bacterium and virus, blood, saliva, lesional tissue, etc. separated from living organisms, and excretion such as enteruria. Further, for performing a prenatal diagnosis, the sample may be a part of a fetus cell or of a dividing egg cell in a test tube. Furthermore, these samples may be, after condensed to a sediment directly or by centrifugation or the like according to necessity, subjected to a pre-treatment for cell destruction through an enzymatic treatment, a thermal treatment, a surfactant treatment, an ultrasonic treatment, any combinations of these, etc.

### EXAMPLES

Examples of the present invention will now be explained below. However, the present invention is not to be limited to these Examples.

In Examples and Comparative Examples below, the voidage of the porous layer was calculated as follows. Further, the hydrophilicity of the base member was evaluated as follows. Furthermore, the melting start temperature of the thermoplastic material was measured as follows.

### <Calculation of Voidage of Porous Layer>

The voidage of the porous layer was calculated according to Calculation Formula 1 below, based on the basis weight (g/m²) and the thickness (μm) of the porous layer, and the specific gravity of the component thereof.

Voidage (%)={1−[basis weight (g/m²)/thickness (μm)/specific gravity of the component]}×100 [Calculation Formula 1]

### <Evaluation of Hydrophilicity of Porous Layer>

The hydrophilicity of the porous layer was evaluated by performing a test for water penetrability evaluation by drying a plate-shaped test piece at 120° C. for 1 hour, and dropping down pure water (0.01 mL) onto the surface of the test piece. Any porous layer sample into which the pure water (0.01 mL) penetrated completely within 10 minutes was evaluated as hydrophilic. Any porous layer sample that had any pure water left not penetrating after 10 minutes was evaluated as hydrophobic.

### <Melting Start Temperature of Thermoplastic Material>

The melting start temperature of the thermoplastic material was measured as a flowing start temperature that was confirmed by hardening the thermoplastic material, introducing it into a cylinder-shaped vessel having an opening of a diameter of 0.5 mm in the bottom, setting the vessel on an elevated flow tester (product name: SHIMADZU FLOW TESTER CFT-100D manufactured by Shimadzu Corporation), raising the temperature of the sample at a constant rate of 5° C./min under a load of a cylinder pressure of 980.7 kPa, and measuring the melt viscosity and flow properties of the sample due to the temperature rise.

### <Melt Viscosity>

The melt viscosity of the thermoplastic material was measured according to a testing method compliant with ISO 11443. In the present embodiment, the melt viscosity was measured at 100° C., which corresponded to a temperature to be reached by the thermoplastic material by being heated by a head.

### Example 1

### Manufacture of Thermal Transfer Medium for Fluidic Device Fabrication

### <Preparation of Flow Path Forming Material Layer Coating Liquid>

Ester wax (WE-11 manufactured by NOF Corporation, melting start temperature of 65° C.) (100 parts by mass) as the thermoplastic material, montanic acid (product name: LUWAX-E manufactured by BASF Japan Ltd., melting point of 76° C.) (2 parts by mass), and long-chain alcohol (manufactured by Nippon Seiro Co., Ltd., melting point of 75° C.) represented by General Formula (1) below (where R¹ represents alkyl group having 28 to 38 carbon atoms) (9 parts by mass) were melted at 120° C. After this, while the resultant was stirred, morpholine (5 parts by mass) was added thereto. Then, hot water of 90° C. was dropped thereinto in an amount that would make the solid content 30% by mass to form an oil-in-water emulsion. After this, the emulsion was cooled to thereby obtain an ester wax aqueous emulsion having a solid content of 30% by mass.

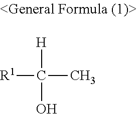

In General Formula (1), R¹ represents alkyl group having 28 to 38 carbon atoms.

The average particle diameter of the obtained ester wax aqueous emulsion was measured with a laser diffraction/scattering particle size distribution analyzer (“LA-920” manufactured by Horiba, Ltd.), and it was 0.4 μm.

Next, the obtained ester wax aqueous emulsion (solid content of 30% by mass) (100 parts by mass), carbon black water dispersion (FUJI SP BLACK 8625 manufactured by Fuji Pigment Co., Ltd., solid content of 30% by mass) (2 parts by mass) were mixed with each other, to thereby obtain a flow path forming material layer coating liquid.

### <Preparation of Releasing Layer Coating Liquid>

Polyethylene wax (POLYWAX 1000 manufactured by Toyo ADL Corporation, melting point of 99° C., penetration of 2 at 25° C.) (14 parts by mass), ethylene-vinyl acetate copolymer (EV-150 manufactured by Du Pont-Mitsui Polychemicals Co., Ltd., weight average molecular weight of 2,100, VAc of 21%) (6 parts by mass), toluene (60 parts by mass), and methyl ethyl ketone (20 parts by mass) were dispersed until the average particle diameter became 2.5 to thereby obtain a releasing layer coating liquid.

### <Preparation of Back Layer Coating Liquid>

A silicone-based rubber emulsion (KS779H manufactured by Shin-Etsu Chemical Co., Ltd., solid content of 30% by mass) (16.8 parts by mass), a chloroplatinic acid catalyst (0.2 parts by mass), and toluene (83 parts by mass) were mixed together, to thereby obtain a back layer coating liquid.

### <Manufacture of Thermal Transfer Medium for Fluidic Device Fabrication>

A polyester film (LUMIRROR F65 manufactured by Toray Industries, Inc.) as a support member having an average thickness of 25 μm was coated over one side thereof with the back layer coating liquid, and dried at 80° C. for 10 seconds, to thereby form a back layer having an average thickness of 0.02 μm.

Next, a side of the polyester film opposite to the side thereof over which the back layer was formed was coated with the releasing layer coating liquid, and dried at 40° C. for 10 seconds, to thereby form a releasing layer having an average thickness of 1.5 μm.

Next, the releasing layer was coated with the flow path forming material layer coating liquid, and dried at 70° C. for 10 seconds, to thereby form a flow path forming material layer having an average thickness of 100 μm. In this way, the thermal transfer medium for fluidic device fabrication of Example 1 was manufactured.

### <Formation of Porous Layer>

After a polyester-based hot-melt adhesive (ALONMELT PES375S40 manufactured by Toagosei Co., Ltd.) was heated to 190° C., a polyethylene terephthalate (PET) film (LUMIRROR S10 manufactured by Toray Industries, Inc., thickness of 50 μm) as a base member was coated with the adhesive with a roll coater to a thickness of 50 μm, to thereby form an adhesive layer. The obtained coated product was kept stationary for 2 hours or longer, and after this, a membrane filter (SVLPO4700 manufactured by Merck Millipore Corporation, thickness of 125 μm, voidage of 70%) as a porous layer was provided over the adhesive layer side, to thereby form a porous layer over the base member under a load of 1 kgf/cm² at a temperature of 150° C. for 10 seconds.

### <Formation of Flow Path Wall by Thermal Transfer>

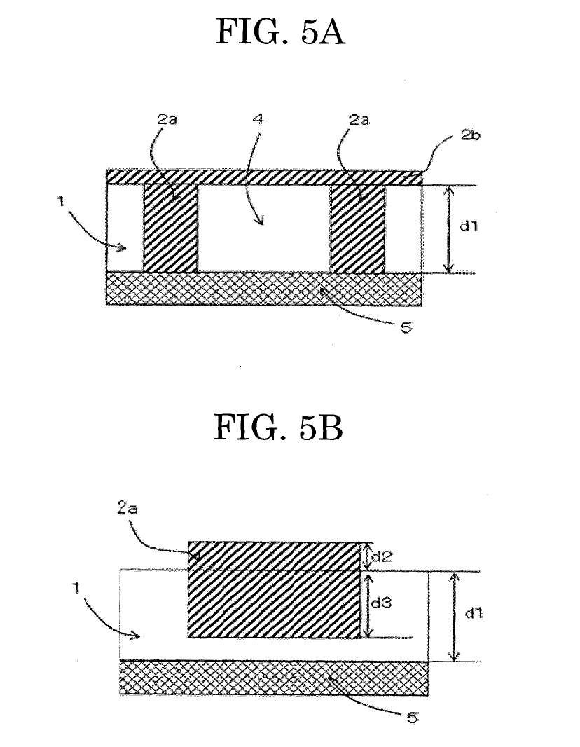

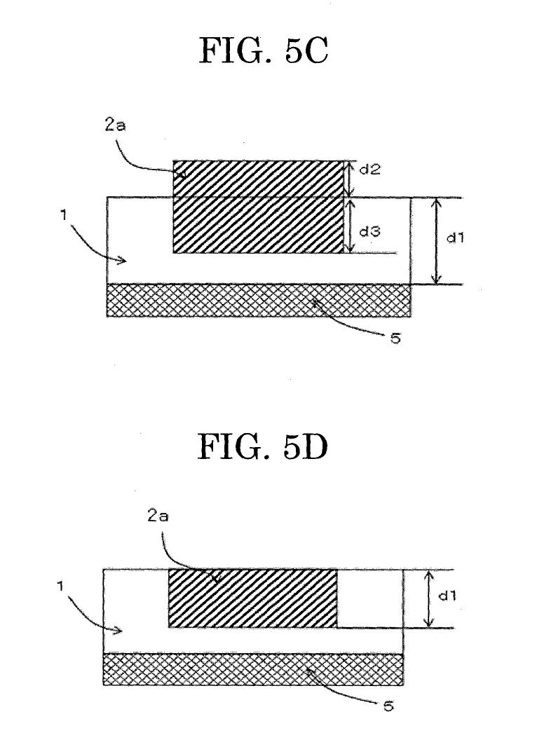

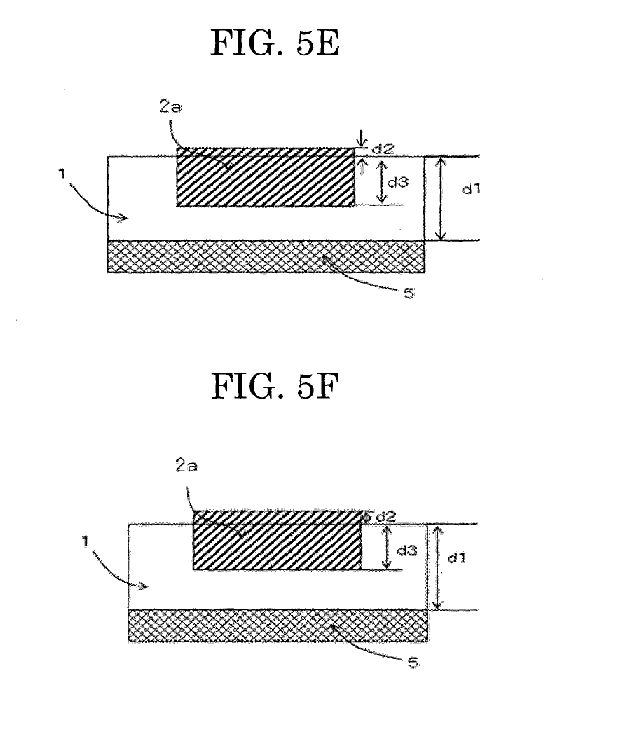

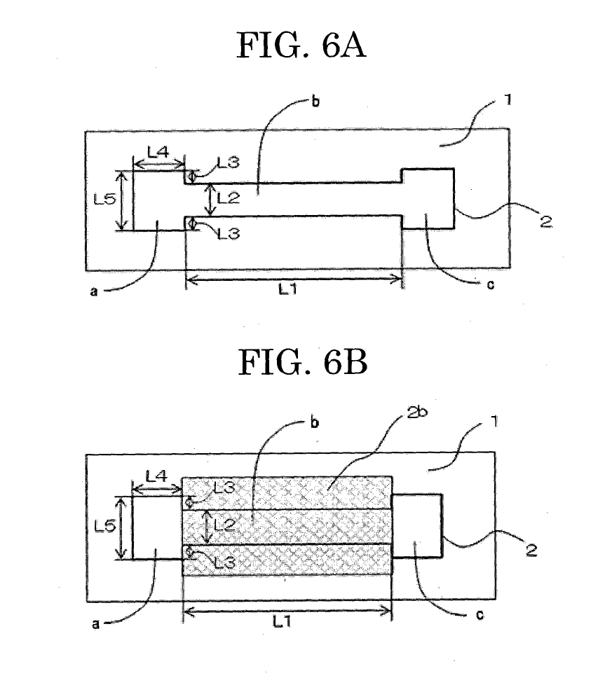

After the thermal transfer medium for fluidic device fabrication and the porous layer over the base member were brought to face each other and overlap with each other, thermal transfer was performed under the conditions described below with the use of a thermal transfer printer described below, to thereby form a flow path b shown in FIG. 6A. After this, the thermal transfer medium for fluidic device fabrication was again brought to face and overlap with the flow path, and a protection layer 2b shown in FIG. 6B was formed over the flow path b with likewise the use of the thermal transfer printer. That is, a fluidic device of Example 1 shown in FIG. 5A and FIG. 6A, which included the flow path b formed by the flow path walls 2a and 2a, the base member 5, and the protection layer 2b shown FIG. 5A was formed.

The formation of the flow path walls was performed by constructing an evaluation system with a thermal head having a head density of 300 dpi (manufactured by TDK Corporation), at an application speed of 16.9 mm/sec, with an applied energy of 0.81 mJ/dot.

The formation of the protection layer 2b was performed by constructing the same evaluation system, except that the applied energy was changed to 0.28 mJ/dot among the above conditions.

Further, in Example 1, as shown in FIG. 4A to FIG. 4C, a flow path having a wall width of 600 μm (at 22 in FIG. 4A), a flow path having a wall width of 800 μm (at 23 in FIG. 4B), and a flow path having a wall width of 1,000 μm (at 24 in FIG. 4C) were formed, as flow paths for evaluation of barrier ability of the flow path walls.

### Example 2

### Fabrication of Fluidic Device

A fluidic device of Example 2 was fabricated in the same manner as Example 1, except that a polyester resin (LP011 manufactured by Nippon Synthetic Chemical Industry Co., Ltd., a melting start temperature of 65° C.) was used in the flow path forming material layer coating liquid instead of WE-11 used in Example 1.

Further, flow paths for barrier ability evaluation shown in FIG. 4A to FIG. 4C were formed in the same manner as Example 1.

### Example 3

### Fabrication of Fluidic Device

A fluidic device of Example 3 was fabricated in the same manner as Example 1, except that a polyester resin (LP050 manufactured by Nippon Synthetic Chemical Industry Co., Ltd., a melting start temperature of 82° C.) was used in the flow path forming material layer coating liquid instead of WE-11 used in Example 1.

Further, flow paths for barrier ability evaluation shown in FIG. 4A to FIG. 4C were formed in the same manner as Example 1.

### Example 4

A fluidic device of Example 4 was fabricated in the same manner as Example 1, except that a synthetic wax (ITOWAX E-210, manufactured by Itoh Oil Chemicals Co., Ltd., a melting start temperature of 50° C.) was used in the flow path forming material layer coating liquid instead of WE-11 used in Example 1.

Further, flow paths for barrier ability evaluation shown in FIG. 4A to FIG. 4C were formed in the same manner as Example 1.

### Example 5

A fluidic device of Example 5 was fabricated in the same manner as Example 1, except that a synthetic wax (ITOWAX J550-S manufactured by Itoh Oil Chemicals Co., Ltd., a melting start temperature of 142° C.) was used in the flow path forming material layer coating liquid instead of WE-11 used in Example 1.

Further, flow paths for barrier ability evaluation shown in FIG. 4A to FIG. 4C were formed in the same manner as Example 1.

### Example 6

A fluidic device of Example 6 was fabricated in the same manner as Example 1, except that the membrane filter used in Example 1 was changed to a qualitative filter (qualitative filter No. 4A manufactured by Advantec Co., Ltd., average thickness of 120 μm, voidage of 48%).

Further, flow paths for barrier ability evaluation shown in FIG. 4A to FIG. 4C were formed in the same manner as Example 1.

### Example 7

A fluidic device of Example 7 was fabricated in the same manner as Example 1, except that the membrane filter used in Example 1 was changed to vinylon paper (product name: PAPYLON BFH NO. 1, manufactured by Kuraray Co., Ltd., average thickness of 58 μm, voidage of 82%).

Further, flow paths for barrier ability evaluation shown in FIG. 4A to FIG. 4C were formed in the same manner as Example 1.

### Comparative Example 1

### Fabrication of Fluidic Device

A fluidic device of Comparative Example 1 was fabricated in the same manner as Example 1, except that a PET film (LUMIRROR S10 manufactured by Toray Industries, Inc., thickness of 50 μm) free of voids was used instead of the membrane filter of Example 1. However, it was impossible to form a flow path in Comparative Example 1.

### Comparative Example 2

### Fabrication of Fluidic Device

A fluidic device of Comparative Example 2 was fabricated in the same manner as Example 1, except that WE-11 used in the flow path forming material layer coating liquid in Example 1 was changed to a synthetic wax (CPAO manufactured by Idemitsu Kosan Co., Ltd., melting start temperature of 40° C.). However, in Comparative Example 2, it was impossible to form a flow path that could ensure a barrier ability, because the wax had a low melting start temperature, and hence the wax easily spread inside the porous layer and could not sufficiently fill the voids in the porous layer under the condition of the value range of the pattern width for barrier ability evaluation.

### Comparative Example 3

### Fabrication of Fluidic Device

A fluidic device of Comparative Example 3 was fabricated in the same manner as Example 1, except that WE-11 used in the flow path forming material layer coating liquid in Example 1 was changed to a polyamide resin (PA-105A manufactured by T&K TOKA Corporation, melting start temperature of 164° C.). However, it was impossible to form a flow path in Comparative Example 3.

### Comparative Example 4

### Fabrication of Fluidic Device using Inkjet Printer (Ultraviolet Curable Ink)

A fluidic device of Comparative Example 4 was fabricated in the same manner as Example 1, except that the method for forming flow path walls was changed to the following.

### <Formation of Flow Path Walls by Inkjet Printer (Ultraviolet Curable Ink)>

A mixture of octadecyl acrylate, which was a photo-radical polymerizable monomer, and 1,10-bis(acryloyloxy)decane (DDA), which was a photo-radical polymerizable oligomer, with a mixing ratio of 7:3 (on a mass basis) was prepared. Benzyl dimethyl ketal (BDK), which was a photo-polymerizable initiator, was dissolved in the obtained mixture, so as to have a final concentration of 15% by mass, to thereby obtain an ultraviolet curable (UV) ink.

Ink cartridges of a piezo inkjet printer (PX-101 manufactured by Seiko Epson Corp.) were filled with the UV ink prepared above, and a flow path was printed in a sheet. Similarly to FIG. 6A, the printed flow path had a shape that was formed by linking two squares each having 9 mm on each side with a path having a length of 40 mm and a width of 5 mm. The printing was performed by filling all cartridges with the UV ink, and setting a monochrome printing mode, based on a flow path pattern that was drawn with a drawing software program. A qualitative filter (qualitative filter No. 4A manufactured by Advantec Co., Ltd., average thickness of 0.12 mm, voidage of 48%) was used as the sheet.

Further, flow paths for barrier ability evaluation shown in FIG. 4A to FIG. 4C were formed in the same manner as Example 1.

### Comparative Example 5

### Fabrication of Fluidic Device using Wax Printer (Solid Wax Ink)

A fluidic device of Comparative Example 5 was fabricated in the same manner as Example 1, except that the method for forming flow path walls was changed to the following.

<Formation of Flow Path Walls using Wax Printer (Solid Wax Ink)>

A flow path was formed in a sheet with the use of PHASER 8560N BLACK SOLID INK (genuine ink) as the solid wax ink and with the use of a commercially-available thermal inkjet printer (PHASER 8560N) manufactured by Xerox Co., Ltd. Similarly to FIG. 6A, the formed flow path had a shape that was formed by linking two squares each having 9 mm on each side with a path having a length of 40 mm and a width of 5 mm. The printing was performed by setting a monochrome printing mode, based on a flow path pattern that was drawn with a drawing software program. A qualitative filter (qualitative filter No. 4A manufactured by Advantec Co., Ltd., average thickness of 0.12 mm, voidage of 48%) was used as the sheet. Next, the printed flow path was heated at 120° C. for 20 minutes with a digital hot plate (CORNING PC-600D manufactured by Corning Incorporated), in order to make the wax completely penetrate into the sheet).

Further, flow paths for barrier ability evaluation shown in FIG. 4A to FIG. 4C were formed in the same manner as Example 1.

TABLE 1-1

| | | | | Energy applied by |
|---|---|---|---|---|
| | Flow path formed by flow path walls formed in porous layer | | | thermal head |
| | Thermoplastic material | | | when forming flow |
| | | | Melting start | path walls |
| | Kind | Product name | temperature (° C.) | (mJ/dot) |
| Ex. 1 | Ester wax | WE-11 | 65 | 0.81 |
| Ex. 2 | Polyester resin | LP011 | 65 | 0.81 |
| Ex. 3 | Polyester resin | LP050 | 82 | 0.81 |
| Ex. 4 | Synthetic wax | ITOWAX E-210 | 50 | 0.81 |
| Ex. 5 | Synthetic wax | ITOWAX J550-S | 142 | 0.81 |
| Ex. 6 | Ester wax | WE-11 | 65 | 0.81 |
| Ex. 7 | Ester wax | WE-11 | 65 | 0.81 |
| Comp. | Ester wax | WE-11 | 65 | 0.81 |
| Ex. 1 | | | | |
| Comp. | Synthetic wax | CPAO | 40 | 0.81 |
| Ex. 2 | | | | |
| Comp. | Polyamide resin | PA-105A | 164 | 0.81 |
| Ex. 3 | | | | |
| Comp. | Ultraviolet curable | Ink prepared in | — | — |
| Ex. 4 | resin | Comp. Ex. 4 | | |
| Comp. | Thermoplastic resin | Genuine ink | 100 | — |
| Ex. 5 | | | | |

TABLE 1-2

| | | | | | Energy |
|---|---|---|---|---|---|
| | | | | | applied by |
| | | | | | thermal |
| | | | | | head when |
| | Porous layer | | | | forming |
| | | | Average | Protection | protection |
| | | Voidage | thickness | layer | layer |
| | Kind | (%) | (μm) | Material | (mJ/dot) |
| Ex. 1 | Membrane filter | 70 | 125 | Ester wax | 0.28 |
| Ex. 2 | Membrane filter | 70 | 125 | Polyester | 0.28 |
| | | | | resin | |
| Ex. 3 | Membrane filter | 70 | 125 | Polyester | 0.28 |
| | | | | resin | |
| Ex. 4 | Membrane filter | 70 | 125 | Synthetic | 0.28 |
| | | | | wax | |
| Ex. 5 | Membrane filter | 70 | 125 | Synthetic | 0.28 |
| | | | | wax | |
| Ex. 6 | Qualitative filter | 48 | 120 | Ester wax | 0.28 |
| Ex. 7 | Vinylon paper | 82 | 58 | Ester wax | 0.28 |
| Comp. | PET | 0 | 50 | Ester wax | 0.28 |
| Ex. 1 | | | | | |
| Comp. | Membrane filter | 70 | 125 | Synthetic | 0.28 |
| Ex. 2 | | | | wax | |
| Comp. | Membrane filter | 70 | 125 | Polyamide | 0.28 |
| Ex. 3 | | | | resin | |
| Comp. | Membrane filter | 70 | 125 | — | — |
| Ex. 4 | | | | | |
| Comp. | Membrane filter | 70 | 125 | — | — |
| Ex. 5 | | | | | |

Next, the fluidic devices of Examples and Comparative Examples manufactured were evaluated in terms of presence or absence of erosion of the flow path walls (barrier ability) as follows. The results are shown in Table 2. In Table 2, the results of FIG. 4A (barrier width of 600 μm), FIG. 4B (barrier width of 800 μm), and FIG. 4C (barrier width of 1,000 μm) are shown.

### <Evaluation of Presence or Absence of Erosion of Flow Path Walls (Barrier Ability)>

With a micropipette, a sample liquid (distilled water colored in red with an edible dye (edible red No. 2, amaranth)) (35 μL) was dropped down into the flow path of each fluidic device, and kept there for 10 minutes. After this, presence or absence of erosion of the flow path walls by the sample liquid was visually observed, and the number of flow path walls having “erosion” in the flow path walls was counted and evaluated based on the following criteria.

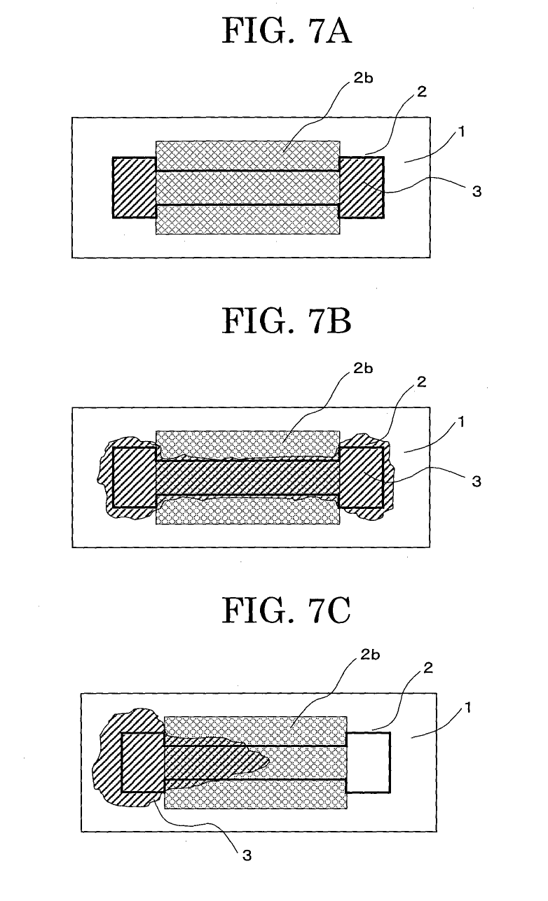

As for judgment of presence or absence of erosion of the flow path walls in the fluidic device, the state shown in FIG. 7A in which the sample liquid was kept within the flow path walls was judged as having “no erosion”, and the state shown in FIG. 7B in which the sample liquid leaked to the outside from part of the flow path walls and the state shown in FIG. 7C in which the sample liquid leaked to the outside from the whole of the flow path walls were judged as having “erosion”.

### [Evaluation Criteria]

A1: the number of fluidic devices including flow path walls having “erosion” was from 0 to 3 out of 10 devices.

B1: the number of fluidic devices including flow path walls having “erosion” was from 4 to 8 out of 10 devices.

C1: the number of fluidic devices including flow path walls having “erosion” was from 9 to 10 out of 10 devices.

TABLE 2
Presence or absence of erosion of flow path walls (barrier ability)

| | Pattern | | Pattern |
|---|---|---|---|
| | width: 600 μm | Pattern width: 800 μm | width: 1,000 μm |
| Ex. 1 | A1 | A1 | A1 |
| Ex. 2 | A1 | A1 | A1 |
| Ex. 3 | A1 | A1 | A1 |
| Ex. 4 | A1 | A1 | A1 |
| Ex. 5 | B1 | B1 | B1 |
| Ex. 6 | A1 | A1 | A1 |
| Ex. 7 | A1 | A1 | A1 |
| Comp. | Could not be measured | | |
| Ex. 1 | | | |
| Comp. | C1 | C1 | B1 |
| Ex. 2 | | | |
| Comp. | Could not be measured | | |
| Ex. 3 | | | |
| Comp. | C1 | C1 | B1 |
| Ex. 4 | | | |
| Comp. | C1 | C1 | B1 |
| Ex. 5 | | | |

From the results of Table 2, it turned out that the liquid impenetrability (barrier ability) of the flow path walls forming the flow path was higher in the fluidic devices of Examples 1 to 7 than in the fluidic devices of Comparative Examples 1 to 5.

### <Evaluation of Linearity of Continuous Line of Contour of Inner Surface of Flow Path Walls>

Examples 1 to 7 and Comparative Examples 1 to 5 were subjected to quantification (linearity measurement) by means of numerical process by image analysis as follows, in terms of the linearity of a continuous line of the contour of the inner surface of the flow path walls.

Specifically, a flow path 4 shown in FIG. 8 was formed in the porous layer of the fluidic device, and a 0.07% by mass aqueous solution of a red pigment (CARMINE RED KL-80 manufactured by Kiriya Chemical Co., Ltd.) was let to flow in the flow path in order to clarify the boundary between the flow path 4 and a flow path wall 2a in an edge portion (indicated by X in FIG. 8). FIG. 9 shows a stained flow path of the fluidic device of Comparative Example 4, in which the flow path was formed with an UV ink with an inkjet printer. FIG. 11 shows a flow path of the fluidic device of Example 1 stained in the same manner. It was confirmed that both of the flow paths were stained completely.

Next, with an optical microscope (DIGITAL MICROSCOPE VHX-1000 manufactured by Keyence Corporation), the stained flow path was enlarged at a magnification of ×100, and was recorded in the form of a digital image.

The resolution of the digital image was 40 dots/mm, and the viewing field was 30 mm×30 mm.

The obtained digital image was processed with an image processing software program (IMAGE J; free software).

Next, an edge emphasizing process (a Find Edge command) was executed to further clarify the boundary between the flow path 4 and the flow path wall 2a. The resulting image of Comparative Example 4 is shown in FIG. 10, and the same for Example 1 is shown in FIG. 12.

In Comparative Example 4, the UV ink coated for forming the barrier spread in the surface of the porous layer non-uniformly in the linear portion of the edge as shown in FIG. 10. This makes the boundary between the flow path 4 and the flow path wall 2a non-linear (undulated) in a top view, and a linearity failure was confirmed. Meanwhile, in Example 1, it could be seen that the boundary between the flow path 4 and the flow path wall 2a was linear as shown in FIG. 12.

Next, with the images of FIG. 10 and FIG. 12, a straight line having a length B of 10 mm was defined between arbitrary two points on the contour of the inner surface of the flow path wall, and a corresponding length A of a continuous line of the contour of the inner surface of the flow path wall was measured in a main-scanning direction D1 and a sub-scanning direction D2 of the inner surface of the flow path wall. A line segment distance measurement (a Perimeter command) of the image processing software program (IMAGE J) was used for the measurement of the length A of a continuous line of the contour. In Comparative Example 4 shown in FIG. 10, the length A of a continuous line of the contour corresponding to the straight line that was between the arbitrary two points on the contour and had the length B (10 mm) was 14.2 mm in the main-scanning direction D1 of the flow path wall and 15.6 mm in the sub-scanning direction D2 of the flow path wall. In Example 1 shown in FIG. 12, the length A of a continuous line of the contour corresponding to the straight line that was between the arbitrary two points on the contour and had the length B (10 mm) was 10.4 mm in the main-scanning direction D1 of the flow path wall and 10.6 mm in the sub-scanning direction D2 of the flow path wall.

Here, the linearity (%) of a continuous line of the contour of the inner surface of the flow path wall was calculated according to Linearity (%) {[A (mm)−B (mm)]/B (mm)}×100. The linearity was an average obtained by measuring ten different measurement positions as shown in FIG. 13, and averaging the obtained measurement values.

In Comparative Example 4, the linearity in the main-scanning direction D1 was 42% (=(14.2−10)/10×100), and the linearity in the sub-scanning direction D2 was 56% (=(15.6−10)/10×100).

In Example 1, the linearity in the main-scanning direction D1 was 4% (=(10.4−10)/10×100), and the linearity in the sub-scanning direction D2 was 6% (=(10.6−10)/10×100).

The linearity of a continuous line of the contour of the inner surface of the flow path wall was measured for Examples 2 to 7 and Comparative Examples 1 to 3 and 5 in the same manner, and evaluated based on the following criteria. The results are shown in Table 3.

A linearity closer to 0% indicates that a continuous line of the contour of the inner surface of the flow path wall was more linear (had a greater linearity). A larger linearity indicates that a continuous line of the contour of inner surface of the flow path wall had more undulations and a less linearity.

### [Criteria for Linearity Evaluation]

A2: the linearity was 10% or lower, and favorable.

B2: the linearity was 30% or lower but greater than 10% and slightly faulty.

C2: the linearity was greater than 30% and faulty.

TABLE 3

| | Main-scanning | | | Sub-scanning | | | |
|---|---|---|---|---|---|---|---|
| | direction: D1 | | | direction: D2 | | | Line- |
| | | | Line- | | | Line- | arity |
| | Length | Length | arity | Length | Length | arity | evalu- |
| | B (mm) | A (mm) | (%) | B (mm) | A (mm) | (%) | ation |
| Ex. 1 | 10.0 | 10.4 | 4 | 10.0 | 10.6 | 6 | A2 |
| Ex. 2 | 10.0 | 10.3 | 3 | 10.0 | 10.7 | 7 | A2 |
| Ex. 3 | 10.0 | 10.2 | 2 | 10.0 | 10.7 | 7 | A2 |
| Ex. 4 | 10.0 | 10.3 | 3 | 10.0 | 10.8 | 8 | A2 |
| Ex. 5 | 10.0 | 10.9 | 9 | 10.0 | 11.4 | 14 | B2 |
| Ex. 6 | 10.0 | 10.4 | 4 | 10.0 | 10.9 | 9 | A2 |
| Ex. 7 | 10.0 | 10.5 | 5 | 10.0 | 11.0 | 10 | A2 |
| Comp. | Could not be measured | | | | | | |
| Ex. 1 | | | | | | | |
| Comp. | 10.0 | 14.5 | 45 | 10.0 | 15.3 | 53 | C2 |
| Ex. 2 | | | | | | | |
| Comp. | Could not be measured | | | | | | |
| Ex. 3 | | | | | | | |
| Comp. | 10.0 | 14.2 | 42 | 10.0 | 15.6 | 56 | C2 |
| Ex. 4 | | | | | | | |
| Comp. | 10.0 | 13.8 | 38 | 10.0 | 14.9 | 49 | C2 |
| Ex. 5 | | | | | | | |

From the results of Table 3, it turned out that Examples 1 to 7 had more preferable linearity than Comparative Examples 1 to 5.

### Example 8

### Fabrication of Fluidic Device

A fluidic device of Example 8 was fabricated in the same manner as Example 1, except that a flow path 4 having the shape shown in FIG. 6A and formed by the flow path wall 2a shown in FIG. 5B was formed with a thickness of 50 μm in a single surface of a membrane filter (SVLPO4700 manufactured by Merck Millipore Corporation, thickness of 125 μm, voidage of 70%) as a porous layer that was provided over a polyethylene terephthalate (PET) film (LUMIRROR S10 manufactured by Toray Industries Inc., thickness of 50 μm) as a base member, and formation of the flow path was performed by constructing an evaluation system with a thermal head having a head density of 300 dpi (manufactured by TDK Corporation), at an application speed of 16.9 mm/sec, and with applied energy of 0.59 mJ/dot.

The cross-sectional shape of the flow path 4 of the fabricated fluidic device of Example 8 was observed with an optical microscope (DIGITAL MICROSCOPE VHX-1000 manufactured by Keyence Corporation). As a result, it was confirmed that the flow path wall 2a was formed such that a portion d2 thereof that was exposed above the surface of the porous layer 1 was 34 μm, and a portion d3 thereof that penetrated into the porous layer was 89 μm in the direction of the thickness of the porous layer (see FIG. 5B).

### Example 9

### Fabrication of Fluidic Device

A fluidic device of Example 9 was fabricated in the same manner as Example 1, except that a flow path 4 having the shape shown in FIG. 6A and formed by a flow path wall 2a shown in FIG. 5C was formed in a single surface of a porous layer over a base member, and formation of the flow path was performed by constructing an evaluation system with a thermal head having a head density of 300 dpi (manufactured by TDK Corporation), at an application speed of 16.9 mm/sec, and with applied energy of 0.44 mJ/dot.

The cross-sectional shape of the flow path 4 of the fabricated fluidic device of Example 9 was observed with an optical microscope (DIGITAL MICROSCOPE VHX-1000 manufactured by Keyence Corporation). As a result, it was confirmed that the flow path wall 2a was formed such that a portion d2 thereof that was exposed above the surface of the porous layer 1 was 44 μm, and a portion d3 thereof that penetrated into the porous layer was 73 μm in the direction of the thickness of the porous layer (see FIG. 5C).

### Example 10

### Fabrication of Fluidic Device

A fluidic device of Example 10 was fabricated in the same manner as Example 1, except that the average thickness of the porous layer 1 was changed from 100 μm of Example 1 to 75 μm, a flow path 4 having the shape of FIG. 6A and formed by a flow path wall 2a shown in FIG. 5D was formed in a single surface of the porous layer over the base member, and formation of the flow path was performed by constructing an evaluation system with a thermal head having a head density of 300 dpi (manufactured by TDK Corporation), at an application speed of 16.9 mm/sec, and with applied energy of 0.48 mJ/dot.

The cross-sectional shape of the flow path of the fabricated fluidic device of Example 10 was observed with an optical microscope (DIGITAL MICROSCOPE VHX-1000 manufactured by Keyence Corporation). As a result, it was confirmed that there was no portion that was exposed above the surface of the porous layer 1 and the whole portion completely penetrated into the porous layer in the direction of the thickness of the porous layer. It was also confirmed that the portion d1 penetrated into the porous layer was 95 μm (see FIG. 5D).

### Example 11

### Fabrication of Fluidic Device

A fluidic device of Example 11 was fabricated in the same manner as Example 10, except that formation of the flow path was performed by constructing an evaluation system with a thermal head having a head density of 300 dpi (manufactured by TDK Corporation), at an application speed of 16.9 mm/sec, with applied energy of 0.47 mJ/dot unlike in Example 10.

The cross-sectional shape of the flow path of the fabricated fluidic device of Example 11 was observed with an optical microscope (DIGITAL MICROSCOPE VHX-1000 manufactured by Keyence Corporation). As a result, it was confirmed that the flow path wall 2a was formed such that a portion d2 thereof that was exposed above the surface of the porous layer 1 was 12 μm, and a portion d3 thereof that penetrated into the porous layer was 89 μm in the direction of the thickness of the porous layer (see FIG. 5E).

### Example 12

### Fabrication of Fluidic Device

A fluidic device of Example 12 was fabricated in the same manner as Example 10, except that formation of the flow path was performed by constructing an evaluation system with a thermal head having a head density of 300 dpi (manufactured by TDK Corporation), at an application speed of 16.9 mm/sec, with applied energy of 0.37 mJ/dot unlike in Example 10.

The cross-sectional shape of the flow path of the fabricated fluidic device of Example 12 was observed with an optical microscope (DIGITAL MICROSCOPE VHX-1000 manufactured by Keyence Corporation). As a result, it was confirmed that the flow path wall 2a was formed such that a portion d2 thereof that was exposed above the surface of the porous layer 1 was 23 μm, and a portion d3 thereof that penetrated into the porous layer was 70 μm in the direction of the thickness of the porous layer (see FIG. 5F).

### Example 13

A fluidic device including a flow path shown in FIG. 6A and FIG. 6B was fabricated in the same manner as Example 1.

The reaction region c shown in FIG. 6A and FIG. 6B was coated with a pH indicator (a 0.04% by mass BTB solution manufactured by Wako Pure Chemical Industries, Ltd.) and dried. At this time, the reaction region was yellow. After this, a clear, and colorless 1% by mass NaOH solution (35 μL) was dropped down into a sample addition region a. As a result, the solution penetrated from the sample addition region a through a flow path b by a capillary action, and reached the reaction region c. In the reaction region c, it was confirmed that the NaOH solution reacted with the pH indicator, and the reaction region turned blue from yellow. From this, it was confirmed that the fluidic device of Example 13 shown in FIG. 6A and FIG. 6B functioned as a chemical sensor.

### Example 14

A nitrocellulose membrane filter (HI-FLOW PLUS HF075UBXSS manufactured by Merck Millipore Corporation, thickness of 135 μm, voidage of 70%) was used instead of the membrane filter of Example 1. The nitrocellulose membrane filter was bonded to a PET film, and the following blocking treatment was applied to the nitrocellulose membrane filter.

### [Blocking Treatment]

The PET film to which the nitrocellulose membrane filter was bonded was immersed in a blocking agent (a PBS solution containing BSA, P3688-10 PAK manufactured by Sigma-Aldrich Co., LLC, (pH 7.4)), and shaken gently for 20 minutes. After this, excess moisture on the surface of the film was sucked, and the film was dried at room temperature.

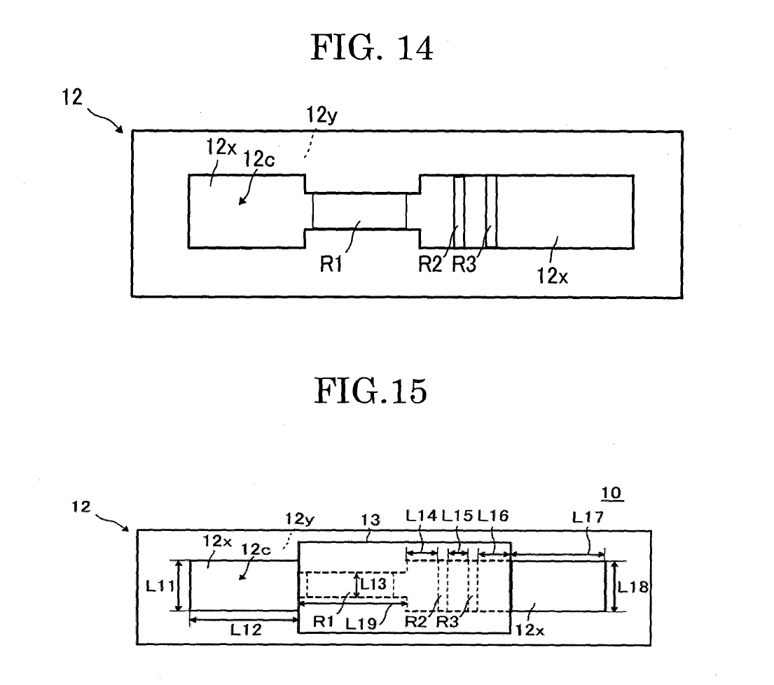

A flow path shown in FIG. 14 was formed in the nitrocellulose membrane filter to which the blocking treatment was applied.

Next, the reaction region R2 shown in FIG. 14 was coated with an anti-human IgG antibody (11886 manufactured by Sigma-Aldrich Co., LLC, 4.7 mg/mL) (6 μL) with a width of 1 mm as a test line, and the reaction region R3 was coated with a human IgG (12511-10MG manufactured by Sigma-Aldrich Co., LLC, 4.8 mg/mL) (6 μL) with a width of 1 mm as a control line, and they were dried at room temperature for 30 minutes to 60 minutes.

Next, the reaction region R1 shown in FIG. 14 was coated with a gold-colloid-labeled anti-human IgG (manufactured by BAW Inc., Gold of 40 nm, OD=15) (5 μL), as a gold-colloid-labeled antibody.

Further, the thermal transfer medium for fluidic device fabrication was again brought to face and overlap with the flow path shown in FIG. 14. After this, a protection layer 2b was formed with a thermal transfer printer under the same printing conditions as Example 1, to thereby fabricate the fluidic device of Example 14 shown in FIG. 15.

Next, a solution of 2 mg/mL of human IgG diluted with purified water (50 μL) was dropped down into the sample addition region 12c of the fluidic device of Example 14 shown in FIG. 15. As a result, it was confirmed that the solution penetrated through the flow path by a capillary action, and lines having a width of 1 mm appeared in the reaction region R2 (test line) and in the reaction region R3 (control line). From this, it was confirmed that the fluidic device functioned as a biochemical sensor.

### Example 15

A fluidic device of Example 15 was fabricated in the same manner as Example 1, except that the protection layer to be provided over the flow path defined by the flow path wall in the porous layer was formed with the use of the flow path forming material layer coating liquid of Example 2 unlike in Example 1.

### Comparative Example 6

A fluidic device of Comparative Example 6 was fabricated in the same manner as Example 1, except that a protection layer was not provided over the flow path defined by the flow path wall in the porous layer.

### Comparative Example 7

A fluidic device of Comparative Example 7 was fabricated in the same manner as Example 1, except that the protection layer to be provided over the flow path defined by the flow path wall in the porous layer was formed by pasting a hydrophobic film (FILMOLUX 609 manufactured by Filmolux Co., Ltd., thickness of 70 μm; bonded to the flow path wall).

### <Evaluation of Gas Barrier Ability>

A sample liquid (distilled water colored in red with an edible dye (edible red No. 2, amaranth)) (35 μL) was dropped clown into the flow path of the fluidic device of each of Examples 1 and 15 and Comparative Examples 6 and 7 with a micropipette. Then, the dropped sample liquid was heated and dried with a hot plate (HHP-170D manufactured by AS ONE Corporation) that was heated to 50° C. for 5 hours, and after this, the difference in the amount of the dropped liquid by evaporation was measured, to thereby evaluate the gas barrier ability of the fluidic device. The results are shown in Table 4.

The amount of evaporation was calculated according to the following formula, based on the difference between the weight W1 (mg) of the fluidic device before the sample liquid was dropped down, and the weight W2 (mg) of the fluidic device after dried.

Amount of evaporation=W1 (mg)−W2 (mg)

W1 and W2 were measured with a balance (an electric balance for analysis GR202 manufactured by A&D Co., Ltd.).

TABLE 4

| | | Amount of | Rate of |
|---|---|---|---|
| | | evaporation | evaporation |
| | Protection layer | [mg] | [%] |
| Ex. 1 | Ester wax (WE-11) | 2.9 | 0.08 |
| Ex. 15 | Polyester resin (LP011) | 3.1 | 0.09 |
| Comp. Ex. 6 | Absent | 35.0 | 100 |
| Comp. Ex. 7 | Filmolux | 33.4 | 95 |

From the results of Table 4, it turned out that the gas barrier ability of the protection layer is higher in the fluidic devices of Examples 1 and 15 than in Comparative Examples 6 and 7.

<Evaluation of Fusion between Protection Layer and Flow Path Wall by Scotch Tape>

In each of the fluidic devices of Examples 1 and 15 and Comparative Example 7, scotch tape (SCOTCH MENDING TAPE 810 manufactured by 3M Ltd.) was pasted to a 1 cm×1 cm area of the surface of the protection layer 2b provided over the flow path 4 defined by the flow path wall 2a in the porous layer. After this, the tape was peeled away by a hand, and the state of the surface of the flow path wall 2a when the tape was peeled away was observed megascopically and with a loupe at the magnification of ×10, and evaluated based on the following evaluation criteria. The results are shown in Table 5.

### [Evaluation Criteria]

A3: slight separation that could be observed with a loupe did not occur.

B3: slight separation that could be observed with a loupe did occur, but can be judged to be of a non-problematic level megascopically.

C3: separation was observed megascopically.

TABLE 5

| | Fusion with protection layer |
|---|---|
| Ex. 1 | A3 |
| Ex. 15 | B3 |
| Comp. Ex. 7 | C3 |

From the results of Table 5, it turned out that fusion between the flow path wall and the protection layer was stronger in the fluidic devices of Examples 1 and 15 than in the fluidic device of Comparative Example 7.

### Example 16

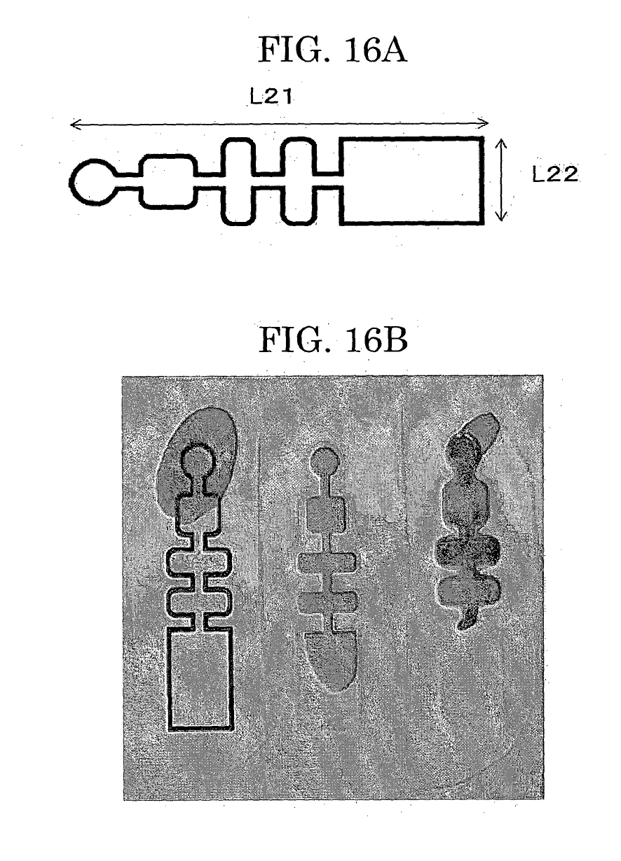

A fluidic device having the flow path shape shown in FIG. 16A was fabricated under the same conditions as Example 1.

A sample liquid (distilled water colored in red with an edible dye (edible red No. 2, amaranth)) was dropped down into the flow path of the obtained fluidic device with a micropipette. As a result, it was confirmed that the sample liquid had flowed through the flow path neatly as shown in the central diagram of FIG. 16B. Further, the cross-sectional shape of the flow path was observed with an optical microscope (DIGITAL MICROSCOPE VHX-1000 manufactured by Keyence Corporation), and it was confirmed that the flow path wall had been formed up to the base member fully in the direction of the thickness of the porous layer without a gap.

### Comparative Example 8

A fluidic device having the flow path shape shown in FIG. 16A was fabricated by using a commercially-available ink ribbon (B110A manufactured by Ricoh Company Ltd.) in Example 1.

A sample liquid was let to flow in the flow path of the obtained fluidic device with a micropipette. As a result, the sample liquid overflowed from the flow path as shown in the left-hand diagram of FIG. 16B. Formation of the flow path wall using the commercially-available ink ribbon was performed by constructing an evaluation system with a thermal head having a head density of 300 dpi (manufactured by TDK Corporation), at an application speed of 16.9 mm/sec, with applied energy of 0.28 mJ/dot.

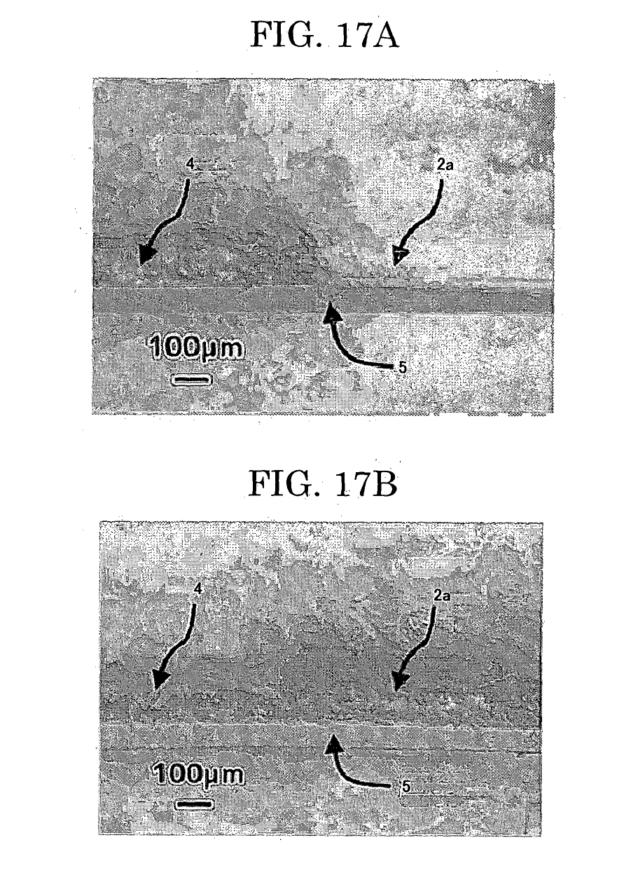

The cross-sectional shape of the flow path was observed, and as a result, it was confirmed that the flow path wall had a gap from the base member in the direction of the thickness of the porous layer as shown in FIG. 17B. This is considered to be because the applied energy when forming the flow path wall was low to thereby keep the ink layer of the commercially-available ink ribbon from penetrating into the interior of the porous layer, but keep it over the surface of the porous layer.

### Comparative Example 9

A fluidic device having the flow path shape shown in FIG. 16A was fabricated in the same manner as Example 1, except that the applied energy was changed from 0.81 mJ/dot of Example 1 to 0.44 mJ/dot.

A sample liquid was let to flow in the flow path of the obtained fluidic device. As a result, the sample liquid overflowed from the flow path as shown in the right-hand diagram of FIG. 16B. This is considered to be because the applied energy when forming the flow path wall was low to thereby keep the ink from completely penetrating into the interior of the sheet but keep it over the surface of the sheet or halfway into the interior of the sheet.

### [Evaluation Criteria]

A4: the flow path wall was not eroded, and the sample liquid flowed through the flow path.

B4: the flow path wall was eroded, and the sample liquid overflowed from the flow path.

TABLE 6

| | Energy applied by thermal | Presence or absence of |
|---|---|---|
| | head when forming flow | erosion of flow |
| | path walls (mJ/dot) | path walls (barrier ability) |
| Ex. 16 | 0.81 | A4 |
| Comp. Ex. 8 | 0.28 | B4 |
| Comp. Ex. 9 | 0.44 | B4 |

### Example 17

### Manufacture of Thermal Transfer Medium for Fluidic Device Fabrication

Ester wax (WE-11 manufactured by NOF Corporation, melting start temperature of 65° C., melt viscosity of 5 mPa·s) (100 parts by mass) as the thermoplastic material, montanic acid (product name: LUWAX-E manufactured by BASF Japan Ltd., melting point of 76° C.) (2 parts by mass), and long-chain alcohol (manufactured by Nippon Seiro Co., Ltd., melting point of 75° C.) represented by General Formula (1) below (where R¹ represents alkyl group having 28 to 38 carbon atoms) (9 parts by mass) were melted at 120° C. After this, while the resultant was stirred, morpholine (5 parts by mass) was added thereto. Then, hot water of 90° C. was dropped thereinto in an amount that would make the solid content 30% by mass to form an oil-in-water emulsion. After this, the emulsion was cooled to thereby obtain an ester wax aqueous emulsion having a solid content of 30% by mass.

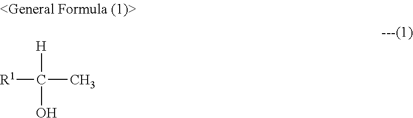

In General Formula (1), R¹ represents alkyl group having 28 to 38 carbon atoms.

The average particle diameter of the obtained ester wax aqueous emulsion was measured with a laser diffraction/scattering particle size distribution analyzer (“LA-920” manufactured by Horiba, Ltd.), and it was 0.4 μm.

Next, the obtained ester wax aqueous emulsion (solid content of 30% by mass) (100 parts by mass) and carbon black water dispersion (FUJI SP BLACK 8625 manufactured by Fuji Pigment Co., Ltd., solid content of 30% by mass) (2 parts by mass) were mixed with each other, to thereby obtain a flow path forming material layer coating liquid.

### <Preparation of Back Layer Coating Liquid>

A silicone-based rubber emulsion (KS779H manufactured by Shin-Etsu Chemical Co., Ltd., solid content of 30% by mass) (16.8 parts by mass), a chloroplatinic acid catalyst (0.2 parts by mass), and toluene (83 parts by mass) were mixed together, to thereby obtain a back layer coating liquid.

### <Manufacture of Thermal Transfer Medium for Fluidic Device Fabrication>

A polyester film (LUMIRROR F65 manufactured by Toray Industries, Inc.) as a support member having an average thickness of 25 μm was coated over one side thereof with the back layer coating liquid, and dried at 80° C. for 10 seconds, to thereby form a back layer having an average thickness of 0.02 μm.

Next, a side of the support member opposite to the side thereof over which the back layer was formed was coated with the flow path forming material layer coating liquid, and dried at 70° C. for 10 seconds, to thereby form a flow path forming material layer having an average thickness of 100 μm. In this way, the thermal transfer medium for fluidic device fabrication of Example 17 was manufactured.

### <Formation of Porous Layer>

After a polyester-based hot-melt adhesive (ALONMELT PES375S40 manufactured by Toagosei Co., Ltd.) was heated to 190° C., a polyethylene terephthalate (PET) film (LUMIRROR S10 manufactured by Toray Industries, Inc., thickness of 50 μm) as a base member was coated with the adhesive with a roll coater to a thickness of 50 μm, to thereby form an adhesive layer. The obtained coated product was kept stationary for 2 hours or longer, and after this, a membrane filter (SVLPO4700 manufactured by Merck Millipore Corporation, thickness of 125 μm, voidage of 70%) as a porous layer was provided over the adhesive layer side, to thereby form a porous layer over the base member under a load of 1 kgf/cm² at a temperature of 150° C. for 10 seconds.

### <Formation of Flow Path Wall by Thermal Transfer>

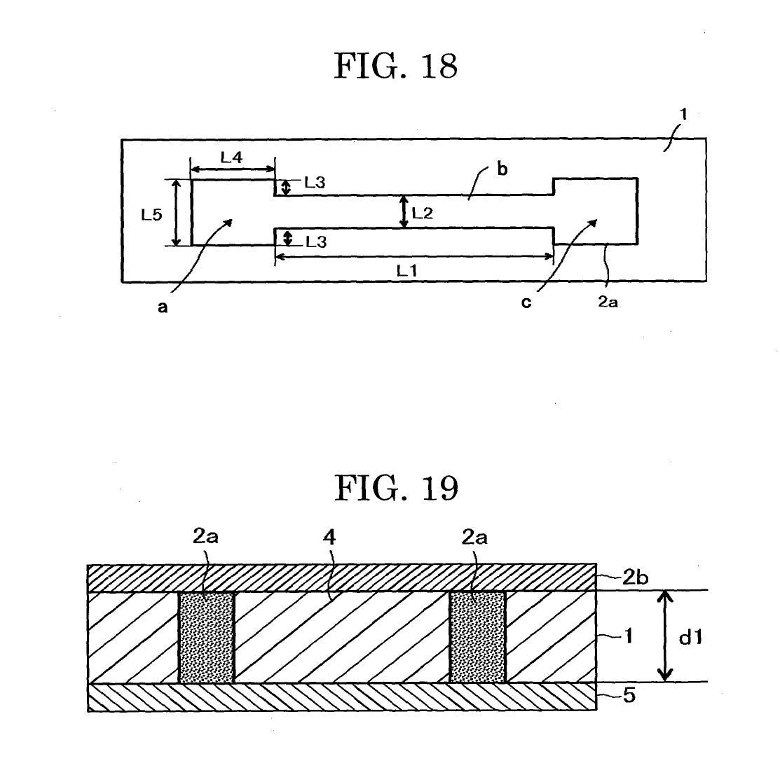

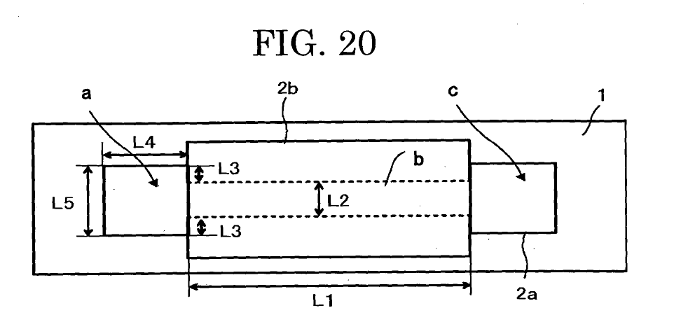

After the manufactured thermal transfer medium for fluidic device fabrication and the porous layer over the base member were brought to face each other and overlap with each other, thermal transfer was performed under the conditions described below with the use of a thermal transfer printer described below, to thereby form a flow path b shown in FIG. 18, where the width of the wall (2a in FIG. 18) defining the flow path was 600 μm. After this, the thermal transfer medium for fluidic device fabrication was again brought to face and overlap with the flow path, and a protection layer 2b shown in FIG. 20 was formed over the flow path b with likewise the use of the thermal transfer printer. That is, a fluidic device of Example 1 shown in FIG. 19 and FIG. 18, which included the flow path b formed by the flow path walls 2a and 2a, the base member 5, and the protection layer 2b shown FIG. 19 was formed.

The formation of the flow path walls was performed by constructing an evaluation system with a thermal head having a head density of 300 dpi (manufactured by TDK Corporation), at an application speed of 16.9 mm/sec, with an applied energy of 0.69 mJ/dot.

The formation of the protection layer 2b was performed by constructing the same evaluation system, except that the applied energy was changed to 0.22 mJ/dot among the above conditions.

### <Fabrication of Fluidic Device for Sensor>

Aside from the fluidic device described above, a thermal transfer medium for fluidic device fabrication and the porous layer over the base member were newly brought to face each other and overlap with each other. After this, thermal transfer was performed under the same conditions as described above, to thereby form a flow path b shown in FIG. 18, where the width of the wall (2a in FIG. 18) defining the flow path was 600 μm. After this, a reaction region c was coated with a pH indicator (a 0.04% by mass BTB solution manufactured by Wako Pure Chemical Industries, Ltd.) and dried. At this time, the reaction region was yellow.

After this, the thermal transfer medium for fluidic device fabrication and the porous layer over the base member were again brought to face each other and overlap with each other, and a protection layer 2b shown in FIG. 20 was formed over the flow path b under the same conditions as described above, to thereby fabricate a fluidic device for sensor.

### Example 18

A thermal transfer medium for fluidic device fabrication was manufactured by forming a flow path forming material layer having an average thickness of 30 μm instead of forming a flow path forming material layer having an average thickness of 100 μm in Example 17.

### <Formation of Porous Layer>

After the thermal transfer medium for fluidic device fabrication and vinylon paper (BFN No. 1 manufactured by Kuraray Co., Ltd., thickness of 58 μm, voidage of 82%) as a porous layer were brought to face each other and overlap with each other, solid image thermal transfer was applied to the entire surface of the porous layer under the conditions indicated below, to thereby form a porous layer having a base member. The cross-sectional shape of the porous layer having the base member was observed with an optical microscope (DIGITAL MICROSCOPE VHX-1000 manufactured by Keyence Corporation). As a result, it was confirmed that such a portion of the flow path forming material layer functioning as the base member that was exposed above the surface of the porous layer was 10 μm, such a portion of the flow path forming material layer functioning as the base member that penetrated into the interior of the porous layer was 24 μm, and the porous layer was 34 μm, in the thickness of the direction of the porous layer.

Formation of the base member was performed by constructing an evaluation system with a thermal head having a head density of 300 dpi (manufactured by TDK Corporation), at an application speed of 16.9 mm/sec, with applied energy of 0.33 mJ/dot.

### <Formation of Flow Path Wall by Thermal Transfer>

A fluidic device of Example 18 was fabricated in the same manner as Example 17, except that the applied energy when forming a flow path wall was changed from 0.68 mJ/dot to 0.43 mJ/dot, and the applied energy when forming a protection layer was changed from 0.22 mJ/dot to 0.11 mJ/dot in the thermal transfer printer evaluation system.

Further, a fluidic device for sensor was fabricated in the same manner as Example 17.

### Example 19

### Manufacture of Thermal Transfer Medium for Fluidic Device Fabrication

A thermal transfer medium for fluidic device fabrication was manufactured by forming a flow path forming material layer having an average thickness of 50 μm instead of forming a flow path forming material layer having an average thickness of 100 μm in Example 17.

### <Formation of Porous Layer>

A porous layer was formed by using vinylon paper (BFN No. 1 manufactured by Kuraray Co., Ltd., thickness of 58 μm, voidage of 82%) as the porous layer, instead of using a membrane filter in Example 17.

### <Formation of Flow Path Wall by Thermal Transfer>

A fluidic device of Example 19 was fabricated in the same manner as Example 17, except that the applied energy when forming a flow path wall was changed from 0.68 mJ/dot to 0.50 mJ/dot, and the applied energy when forming a protection layer was changed from 0.22 mJ/dot to 0.14 mJ/dot in the thermal transfer printer evaluation system.

Further, a fluidic device for sensor was fabricated in the same manner as Example 17.

### Example 20

### Manufacture of Thermal Transfer Medium for Fluidic Device Fabrication

A thermal transfer medium for fluidic device fabrication was manufactured by forming a flow path forming material layer having an average thickness of 120 μm instead of forming a flow path forming material layer having an average thickness of 100 μm in Example 17.

### <Formation of Porous Layer>

A porous layer was formed by using a nitrocellulose membrane filter (HI-FLOW PLUS HF075UBXSS manufactured by Merck Millipore Corporation, thickness of 135 μm, voidage of 70%) as the porous layer, instead of using a membrane filter in Example 17.

### <Formation of Flow Path Wall by Thermal Transfer>

A fluidic device of Example 20 was fabricated in the same manner as Example 17, except that the applied energy when forming a flow path wall was changed from 0.68 mJ/dot to 0.74 mJ/dot, and the applied energy when forming a protection layer was changed from 0.22 mJ/dot to 0.25 mJ/dot in the thermal transfer printer evaluation system.

Further a fluidic device for sensor was fabricated in the same manner as Example 17.

### Example 21

### Manufacture of Thermal Transfer Medium for Fluidic Device Fabrication

A thermal transfer medium for fluidic device fabrication was manufactured by forming a flow path forming material layer having an average thickness of 250 μm, instead of forming a flow path forming material layer having an average thickness of 100 μm in Example 17.

### <Formation of Porous Layer>

A porous layer was formed by using a qualitative filter (WHATMAN QUALITATIVE FILTER #4 manufactured by GE Healthcare Bioscience Corp., thickness of 210 voidage of 72%) as the porous layer in Example 17, instead of using a membrane filter.

### <Formation of Flow Path Wall by Thermal Transfer>

A fluidic device of Example 21 was fabricated in the same manner as Example 17, except that the applied energy when forming a flow path wall was changed from 0.68 mJ/dot to 1.18 mJ/dot, and the applied energy when forming a protection layer was changed from 0.22 mJ/dot to 0.45 mJ/dot in the thermal transfer printer evaluation system.

Further, a fluidic device for sensor was fabricated in the same manner as Example 17.

### Example 22

### Manufacture of Thermal Transfer Medium for Fluidic Device Fabrication

A fluidic device of Example 22 was fabricated in the same manner as Example 17, except that a polyethylene wax (PW400 manufactured by Baker Petrolite Corporation, melting start temperature of 81° C., melt viscosity of 3 mPa·s) was used as the thermoplastic material instead of the ester wax, in the manufacture of the thermal transfer medium for fluidic device fabrication of Example 17.

Further, a fluidic device for sensor was fabricated in the same manner as Example 17.

### Example 23

### Manufacture of Thermal Transfer Medium for Fluidic Device Fabrication

A thermal transfer medium for fluidic device fabrication was manufactured in the same manner as Example 17 except that a flow path forming material layer having an average thickness of 100 μm was formed by using a synthetic wax (DIACARNA manufactured by

Mitsubishi Chemical Corporation, melting start temperature of 86° C., melt viscosity of 160 mPa·s) as the thermoplastic material instead of using the ester wax.

### <Formation of Porous Layer>

A porous layer was formed over a base member in the same manner as Example 17.

### <Formation of Flow Path Wall by Thermal Transfer>

A fluidic device of Example 23 was fabricated in the same manner as Example 17, except that the applied energy when forming a flow path wall was changed from 0.68 mJ/dot to 0.93 mJ/dot, and the applied energy when forming a protection layer was changed from 0.22 mJ/dot to 0.33 mJ/dot in the thermal transfer printer evaluation system.

Further, a fluidic device for sensor was fabricated in the same manner as Example 17.

### Example 24

### Manufacture of Thermal Transfer Medium for Fluidic Device Fabrication

A thermal transfer medium for fluidic device fabrication was manufactured in the same manner as Example 17, except that a flow path forming material layer having an average thickness of 100 μm was formed by using a polyolefin-based resin (POLYTAIL manufactured by Mitsubishi Chemical Corporation, melting start temperature of 94° C., melt viscosity of 1500 mPa·s) as the thermoplastic material instead of using the ester wax.

### <Formation of Porous Layer>

A porous layer was formed over a base member in the same manner as Example 17.

### <Formation of Flow Path Wall by Thermal Transfer>

A fluidic device of Example 24 was fabricated in the same manner as Example 17, except that the applied energy when forming a flow path wall was changed from 0.68 mJ/dot to 1.09 mJ/dot, and the applied energy when forming a protection layer was changed from 0.22 mJ/dot to 0.41 mJ/dot in the thermal transfer printer evaluation system.

Further, a fluidic device for sensor was fabricated in the same manner as Example 17.

### Comparative Example 10

### Preparation of Releasing Layer Coating Liquid

Polyethylene wax (POLYWAX 1000 manufactured by Toyo ADL Corporation, melting point of 99° C., penetration of 2 at 25° C.) (14 parts by mass), ethylene-vinyl acetate copolymer (EV-150 manufactured by Du Pont-Mitsui Polychemicals Co., Ltd., weight average molecular weight of 2,100, VAc of 21%) (6 parts by mass), toluene (60 parts by mass), and methyl ethyl ketone (20 parts by mass) were dispersed until the average particle diameter became 2.5 μm, to thereby obtain a releasing layer coating liquid.

### <Manufacture of Thermal Transfer Medium for Fluidic Device Fabrication>

One surface of a polyester film (LUMIRROR F65 manufactured by Toray Industries, Inc.) as a support member having an average thickness of 25 μm was coated with the back layer coating liquid described above, and dried at 80° C. for 10 seconds, to thereby form a back layer having an average thickness of 0.02 μm.

Next, a surface of the polyester film opposite to the surface over which the back layer was formed was coated with the releasing layer coating liquid, and dried at 40° C. for 10 seconds, to thereby form a releasing layer having an average thickness of 1.5

Next, the releasing layer was coated with the flow path forming material layer coating liquid described above, and dried at 70° C. for 10 seconds, to thereby form a flow path forming material layer having an average thickness of 100 μm.

### <Formation of Flow Path Wall by Thermal Transfer>

A fluidic device of Comparative Example 10 was fabricated under the same conditions as Example 17, using the thermal transfer medium for fluidic device fabrication manufactured as above.

However, in Comparative Example 10, it was impossible to form a flow path that could ensure a barrier ability, because the energy of the thermal transfer printer was insufficient to thereby keep the flow path forming material from penetrating into the porous layer completely in the direction of the thickness, and the voids in the porous layer could not sufficiently be filled with the flow path forming material layer, given the value range of the pattern width for barrier ability evaluation.

### Comparative Example 11

### Manufacture of Thermal Transfer Medium for Fluidic Device Fabrication

A thermal transfer medium for fluidic device fabrication was manufactured by forming a flow path forming material layer having an average thickness of 30 μm in Comparative Example 10, instead of forming a flow path forming material layer having an average thickness of 100 μm.

### <Formation of Porous Layer>

A porous layer of Comparative Example 11 was formed under the same conditions as Example 18, using the thermal transfer medium for fluidic device fabrication manufactured as above.

### <Formation of Flow Path Wall by Thermal Transfer>

A fluidic device of Comparative Example 11 was fabricated under the same conditions as Example 18, using the thermal transfer medium for fluidic device fabrication manufactured as above.

However, in Comparative Example 11, it was impossible to form a flow path that could ensure a barrier ability, because the energy of the thermal transfer printer was insufficient to thereby keep the flow path forming material from penetrating into the porous layer completely in the direction of the thickness, and the voids in the porous layer could not sufficiently be filled with the flow path forming material, given the value range of the pattern width for barrier ability evaluation.

### Comparative Example 12

### Manufacture of Thermal Transfer Medium for Fluidic Device Fabrication

A thermal transfer medium for fluidic device fabrication was manufactured by forming a flow path forming material layer having an average thickness of 250 μm in Comparative Example 10, instead of forming a flow path forming material layer having an average thickness of 100 μm.

### <Formation of Porous Layer>

A porous layer of Comparative Example 12 was formed under the same conditions as Example 21, using the thermal transfer medium for fluidic device fabrication manufactured as above.

### <Formation of Flow Path Wall by Thermal Transfer>

A fluidic device of Comparative Example 12 was fabricated under the same conditions as Example 21, using the thermal transfer medium for fluidic device fabrication manufactured as above.

However, in Comparative Example 12, it was impossible to form a flow path that could ensure a barrier ability, because the energy of the thermal transfer printer was insufficient to keep the flow path forming material from penetrating into the porous layer completely in the direction of the thickness, and the voids in the porous layer could not sufficiently be filled with the flow path forming material, given the value range of the pattern width for barrier ability evaluation.

### Comparative Example 13

### Manufacture of Thermal Transfer Medium for Fluidic Device Fabrication

A thermal transfer medium for fluidic device fabrication was manufactured by forming a flow path forming material layer having an average thickness of 25 μm in Example 17, instead of forming a flow path forming material layer having an average thickness of 100 μm.

### <Formation of Porous Layer>

After the thermal transfer medium for fluidic device fabrication and vinylon paper (BFN No. 1 manufactured by Kuraray Co., Ltd., thickness of 58 μm, voidage of 82%) as a porous layer were brought to face each other and overlap with each other, solid image thermal transfer was applied to the entire surface of the porous layer under the conditions indicated below, to thereby form a porous layer having a base member. The cross-sectional shape of the porous layer having the base member was observed with an optical microscope (DIGITAL MICROSCOPE VHX-1000 manufactured by Keyence Corporation). As a result, it was confirmed that such a portion of the flow path forming material layer as the base member that penetrated into the porous layer was 30 μm and the porous layer was 28 μm in the direction of the thickness of the porous layer.

Formation Of the base member was performed by constructing an evaluation system with a thermal head having a head density of 300 dpi (manufactured by TDK Corporation), at an application speed of 16.9 mm/sec, with applied energy of 0.40 mJ/dot.

### <Formation of Flow Path Wall by Thermal Transfer>

A fluidic device of Comparative Example 13 was fabricated in the same manner as Example 17, except that the applied energy when forming a flow path wall was changed from 0.68 mJ/dot to 0.40 mJ/dot, and the applied energy when forming a protection layer was changed from 0.22 mJ/dot to 0.09 mJ/dot in the thermal transfer printer evaluation system.

Further, a fluidic device for sensor was fabricated in the same manner as Example 17.

However, the fluidic device of Comparative Example 13 could not function as a sensor, as the amount of reagent of the pH indicator was insufficient because the porous layer was thin, and a coloring effect could not be confirmed visually at the concentration of the reagent used in this evaluation.

### Comparative Example 14

### Manufacture of Thermal Transfer Medium for Fluidic Device Fabrication

A thermal transfer medium for fluidic device fabrication was manufactured by forming a flow path forming material layer having an average thickness of 280 μm in Example 17, instead of forming a flow path forming material layer having an average thickness of 100 μm.

### <Formation of Porous Layer>

A porous layer was formed by using a qualitative filter (WHATMAN QUALITATIVE FILTER #4 manufactured by GE Healthcare Bioscience Corp., thickness of 210 voidage of 72%) as the porous layer in Example 17, instead of using a membrane filter.

### <Formation of Flow Path Wall by Thermal Transfer>

A fluidic device of Comparative Example 14 was fabricated in the same manner as Example 17, except that the applied energy when forming a flow path wall was changed from 0.68 mJ/dot to 1.29 mJ/dot, and the applied energy when forming a protection layer was changed from 0.22 mJ/dot to 0.50 mJ/dot in the thermal transfer printer evaluation system.

However, in Comparative Example 14, it was impossible to form a flow path that could ensure a barrier ability, because the flow path forming material layer was so thick that the calorific value of the energy of the thermal transfer printer was insufficient to keep the flow path forming material from penetrating into the porous layer completely in the direction of the thickness, and the voids in the porous layer could not sufficiently be filled with the flow path forming material, given the value range of the pattern width for barrier ability evaluation.

Next, the properties of the fluidic devices of Examples and Comparative Examples thusly manufactured were evaluated as follows. The results are shown in Table 6.

### <Evaluation of Presence or Absence of Erosion of Flow Path Wall (Barrier Ability)>

With a micropipette, a sample liquid (distilled water colored in red with an edible dye (edible red No. 2, amaranth)) (35 μL) was dropped down into the flow path of each fluidic device, and kept there for 10 minutes. After this, presence or absence of erosion of the flow path wall by the sample liquid was visually observed, and the number of fluidic devices having “erosion” was counted and evaluated based on the following criteria. Note that the number n of fluidic devices evaluated for each Example and Comparative Example was 10.

As for judgment of presence or absence of erosion of the flow path wall in the fluidic device, the state shown in FIG. 7A in which the sample liquid was kept within the flow path wall was judged as having “no erosion”, and the states shown in FIG. 7B or FIG. 7C in which the sample liquid leaked to the outside from part of the flow path wall or the sample liquid leaked to the outside from the whole of the flow path wall were judged as having “erosion”.

### [Evaluation Criteria]

A5: the number of fluidic devices including a flow path wall having “erosion” was 0 out of 10 devices.

B5: the number of fluidic devices including a flow path wall having “erosion” was from 1 to 10 out of 10 devices.

### <Evaluation of Sensor Performance>

With a micropipette, a clear and colorless 1% by mass NaOH aqueous solution (35 μL) was dropped down into a sample addition region a in the flow path of the fluidic device for sensor, and kept as it would be for 10 minutes. After this, presence or absence of any resulting color reaction by the NaOH aqueous solution and a pH indicator in the reaction region c was visually observed, and the number of fluidic devices having “a color reaction” was counted and evaluated based on the following criteria. Note that the number n of fluidic devices evaluated for each Example and Comparative Example was 10.

As for judgment of presence or absence of a color reaction in the fluidic device, a fluidic device from which it was confirmed that the reaction region c underwent a color change from yellow to blue was judged as having “a color reaction”, and a fluidic device from which no color change was confirmed or from which no coloring effect was confirmed was judged as having “no color reaction”.

### [Evaluation Criteria]

A6: the number of fluidic devices for sensor having “a color reaction” was 10 out of 10 devices.

B6: the number of fluidic devices for sensor having “no color reaction” was from 0 to 9 out of 10 devices.

TABLE 7

| | Thermal transfer medium | | | | | | | |
|---|---|---|---|---|---|---|---|---|
| | | Thickness of | | | | | | |
| | | flow path form- | Melt | Porous layer | | Applied | Evaluation | |
| | Releasing | ing material | viscosity | Thickness | Voidage | energy | Liquid | |
| | layer | layer (μm) | (mPa · s) | (μm) | (%) | (mJ/dot) | leakage | Sensor |
| Ex. 17 | Absent | 100 | 5 | 125 | 70% | 0.68 | A5 | A6 |
| Ex. 18 | Absent | 30 | 5 | 58 | 82% | 0.43 | A5 | A6 |
| Ex. 19 | Absent | 50 | 5 | 58 | 82% | 0.5 | A5 | A6 |
| Ex. 20 | Absent | 120 | 5 | 135 | 70% | 0.74 | A5 | A6 |
| Ex. 21 | Absent | 250 | 5 | 210 | 72% | 1.18 | A5 | A6 |
| Ex. 22 | Absent | 100 | 3 | 125 | 70% | 0.68 | A5 | A6 |
| Ex. 23 | Absent | 100 | 160 | 125 | 70% | 0.93 | A5 | A6 |
| Ex. 24 | Absent | 100 | 1500 | 125 | 70% | 1.09 | A5 | A6 |
| Comp. | Present | 100 | 5 | 125 | 70% | 0.68 | B5 | Not |
| Ex. 10 | | | | | | | | evaluable |
| Comp. | Present | 30 | 5 | 58 | 82% | 0.43 | B5 | Not |
| Ex. 11 | | | | | | | | evaluable |
| Comp. | Present | 250 | 5 | 210 | 72% | 1.18 | B5 | Not |
| Ex. 12 | | | | | | | | evaluable |
| Comp. | Absent | 25 | 5 | 58 | 82% | 0.4 | A5 | B6 |
| Ex. 13 | | | | | | | | |
| Comp. | Absent | 280 | 5 | 210 | 72% | 1.29 | B5 | Not |
| Ex. 14 | | | | | | | | evaluable |

From the results of Table 6, it turned out that the liquid impenetrability (barrier ability) of the flow path wall forming the flow path was higher in the fluidic devices of Examples 17 to 24 than in the fluidic devices of Comparative Examples 10 to 12 and 14.

Further, it turned out that the coloring effect of the reactive indicator was higher in the fluidic devices for sensor of Examples 17 to 24 than in the fluidic device for sensor of Comparative Example 13.

Aspects of the present invention are as follows, for example.

<1> A fluidic device, including:

a base member;

a porous layer provided over the base member;

a flow path wall provided in the porous layer, and

a flow path defined by an inner surface of the flow path wall and the base member,

wherein linearity of the fluidic device is 30% or less, where the linearity is obtained by the following formula:

Linearity (%)={[A (mm)−B (mm)]/B (mm)}×100, and

wherein a length B is a length of a straight line between arbitrary two points on a contour of the inner surface of the flow path wall, and a length A is a length of a continuous line between arbitrary two points on a contour of the inner surface of the flow path wall.

<2> The fluidic device according to <1>,

wherein the linearity is 15% or less.

<3> The fluidic device according to <1> or <2>,

wherein the flow path wall includes a thermoplastic material.

<4> A fluidic device, including:

a flow path enclosed by:

a base member;

a porous layer provided over the base member;

a flow path wall provided in the porous layer; and

a protection layer provided over the porous layer,

wherein the flow path wall and the protection layer are made of a thermoplastic material and fused with each other.

<5> The fluidic device according to any one of <1> to <4>,

wherein at least a sample addition region, a reaction region, and a detection region are provided in the flow path.

<6> The fluidic device according to <5>,

wherein a protrusion that protrudes above the porous layer is provided along a circumference of an opening defining the sample addition region.

<7> The fluidic device according to any one of <3> to <6>,

wherein the thermoplastic material is at least one selected from the group consisting of fat and oil, and thermoplastic resin.

<8> The fluidic device according to any one of <3> to <7>,

wherein the thermoplastic material has a melting start temperature of from 50° C. to 150° C.

<9> The fluidic device according to any one of <1> to <8>,

wherein the flow path is formed by thermal transfer.

<10> The fluidic device according to any one of <1> to <9>,

wherein the porous layer has an average thickness of from 0.01 mm to 0.3 mm.

<11> The fluidic device according to any one of <1> to <10>,

wherein the fluidic device is used as either one of a chemical sensor and a biochemical sensor.

<12> A thermal transfer medium for fluidic device fabrication, including:

a support member; and

a flow path forming material layer disposed over the support member,

wherein the flow path forming material layer includes a thermoplastic material that penetrates into a porous member constituting a fluidic device when the flow path forming material layer is thermally transferred to the porous member, and

wherein the flow path forming material layer has a thickness of from 30 μm to 250 μm.

<13> The thermal transfer medium for fluidic device fabrication according to <12>,

wherein the flow path forming material layer has a thickness of from 50 μm to 120 μm.

<14> A method for fabricating a fluidic device, including:

placing the flow path forming material layer of the thermal transfer medium for fluidic device fabrication according to <12> or <13> and the porous member so as to overlap with each other, and applying heat and pressure to the thermal transfer medium for fluidic device fabrication to transfer the flow path forming material layer to the porous member and make the thermoplastic material penetrate into the porous member to thereby form a flow path in the porous member.

<15> A fluidic device, including:

a flow path member that is formed by making the thermoplastic material of the thermal transfer medium for fluidic device fabrication according to <12> or <13> penetrate into the porous member.

### REFERENCE SIGNS LIST

1 porous layer
2 flow path wall
2a flow path wall
2b protection layer
3 sample liquid
4 flow path
5 base member
9 protrusion
10 fluidic device
11 base member
12 flow path member
12x porous layer
12y flow path wall
12c sample addition region
13 protection layer
111 back layer
112 support member
113 releasing layer
114 flow path forming material layer
115 thermal transfer medium for fluidic device
R1 reaction region R1
R2 reaction region R2
R3 reaction region R3

1. A fluidic device, comprising:
a base member;
a porous layer provided over the base member;
a flow path wall provided in the porous layer; and
a flow path defined by an inner surface of the flow path wall and the base member,
wherein:
linearity of the fluidic device is 30% or less, where the linearity is obtained by the following formula:
Linearity (%)={[A (mm)−B (mm)]/B (mm)}×100;
a length B is a length of a straight line between arbitrary two points on a contour of the inner surface of the flow path wall; and
a length A is a length of a continuous line between said two points.

2. The fluidic device according to claim 1, wherein the linearity is 15% or less.

3. The fluidic device according to claim 1, wherein the flow path wall comprises a thermoplastic material.

4. A fluidic device, comprising a flow path enclosed by:
a base member;
a porous layer provided over the base member;
a flow path wall provided in the porous layer; and
a protection layer provided over the porous layer,
wherein the flow path wall and the protection layer are made of a thermoplastic material and fused with each other.

5. The fluidic device according to claim 1, wherein at least a sample addition region, a reaction region, and a detection region are provided in the flow path.

6. The fluidic device according to claim 5, wherein:
at least a sample addition region is provided in the flow path; and
a protrusion that protrudes above the porous layer is provided along a circumference of an opening defining the sample addition region.

7. The fluidic device according to claim 4, wherein the thermoplastic material is at least one selected from the group consisting of fat and oil, and a thermoplastic resin.

8. The fluidic device according to claim 4, wherein the thermoplastic material has a melting start temperature of from 50° C. to 150° C.

9. The fluidic device according to claim 1, wherein the flow path is formed by thermal transfer.

10. The fluidic device according to claim 1, wherein the porous layer has an average thickness of from 0.01 mm to 0.3 mm.

11. The fluidic device according to claim 1, wherein the fluidic device is adapted to function as either one of a chemical sensor and a biochemical sensor.

12. A thermal transfer medium for fluidic device fabrication, comprising:
a support member; and
a flow path forming material layer disposed over the support member,
wherein:
the flow path forming material layer comprises a thermoplastic material that penetrates into a porous member constituting a fluidic device when the flow path forming material layer is thermally transferred to the porous member; and
the flow path forming material layer has a thickness of from 30 μm to 250 μm.

13. The thermal transfer medium for fluidic device fabrication according to claim 12, wherein the flow path forming material layer has a thickness of from 50 μm to 120 μm.

14. A method for fabricating a fluidic device, the method comprising:
placing the flow path forming material layer of the thermal transfer medium for fluidic device fabrication according to claim 12 and the porous member so as to overlap with each other;
applying heat and pressure to the thermal transfer medium for fluidic device fabrication;
transferring the flow path forming material layer to the porous member; and
forming a flow path in the porous member by making the thermoplastic material penetrate into the porous member.

15. A fluidic device, comprising a flow path member, wherein the flow path member is formed by making the thermoplastic material of the thermal transfer medium for fluidic device fabrication according to claim 12 penetrate into the porous member.

16. The fluidic device according to claim 4, wherein at least a sample addition region, a reaction region, and a detection region are provided in the flow path.

17. The fluidic device according to claim 16, wherein:
at least a sample addition region is provided in the flow path; and
a protrusion that protrudes above the porous layer is provided along a circumference of an opening defining the sample addition region.

18. The fluidic device according to claim 4, wherein the flow path is formed by thermal transfer.

19. The fluidic device according to claim 4, wherein the porous layer has an average thickness of from 0.01 mm to 0.3 mm.

20. The fluidic device according to claim 4, wherein the fluidic device is adapted to function as either one of a chemical sensor and a biochemical sensor.
